(19) United States
(12) Patent Application Publication
(10) Pub. No.: US 2024/0299938 A1
(43) Pub. Date: Sep. 12, 2024

(54) Point of Care Concentration Analyzer

(71) Applicant: Novilux LLC, Bainbridge Island, WA (US)

(72) Inventors: John David Jolly, Poulsbo, WA (US); Michele Gilbert, Bainbridge Island, WA (US); Richard Livingston, Webster Groves, MO (US); Luis H. Monsalve, Bainbridge Island, WA (US); Brian W. Noland, Temecula, CA (US); Daniel Sheehan; Cathleen Zimmerman, Port Orchard, WA (US); William E. Ortyn, Bainbridge Island, WA (US)

(21) Appl. No.: 18/597,424

(22) Filed: Mar. 6, 2024

Related U.S. Application Data
(60) Provisional application No. 63/488,677, filed on Mar. 6, 2023.
(60) Provisional application No. 63/488,681, filed on Mar. 6, 2023.
(60) Provisional application No. 63/591,546, filed on Oct. 19, 2023.

(51) Int. Cl. B01L 3/00

(52) U.S. Cl. CPC B01L 3/502715; B01L 3/50273; B01L 3/502738; B01L 3/502761; B01L 2200/0668; B01L 2200/10; B01L 2200/16; B01L 2300/0867; B01L 2300/087; B01L 2400/043

(57) ABSTRACT

An analyzer system includes a motor, a dock coupled to the motor, and a cartridge held in the dock. The cartridge includes a fluid circuit configured to receive a sample, isolate a target analyte of the sample, and collect a quantity of a first label that is proportional to a quantity of the target analyte in the sample. The fluid circuit includes a sample port configured to receive a sample, a mixing chamber in fluid communication with the sample port, and a fluid inlet port in fluid communication with the mixing chamber. The fluid circuit includes an isolated path extending from the fluid inlet port to the mixing chamber. The system also includes a fluid delivery line configured to be coupled to the fluid inlet port so as to deliver fluid to the cartridge through the fluid inlet port and push the fluid along the isolated path toward the mixing chamber.

### CROSS REFERENCE TO RELATED APPLICATIONS

This application claims the benefit of US Provisional Patent Application Nos. 63/488,677, filed Mar. 6, 2023, 63/488,681, filed Mar. 6, 2023, and 63/591,546, filed Oct. 19, 2023, each of which is incorporated herein by reference in its entirety.

### FIELD

This invention generally relates to the automated sample processing, measurement and analysis of samples in order to isolate, label, detect and determine the amount of specific target analytes that may be present in very low concentrations.

### BACKGROUND

Numerous studies and advances in the understanding of the underlying causes and the progression of disease have shown that detection of infectious agents or the detection of an impairment at an early stage coupled with appropriate treatment substantially improves clinical outcomes. Many conditions that once required the use of expensive symptomatic measurements like anatomical imaging, which require trained specialist to administer and interpret, can now be diagnosed at the cellular and molecular level via the presence and/or concentration of specific biomarkers. These biomarkers include up- or down-regulated proteins, nucleic acids or other molecules that are highly specific to a disease condition or infection.

It is often desirable to diagnose certain conditions at the point-of-care where timing and administration of the correct treatment is critical for patient outcome. This is especially true in the acute care settings of trauma centers where patients may have experienced an acute myocardial infarction (AMI), acutely decompensated heart failure, pulmonary embolism, sepsis, or other conditions requiring a timely response. In non-acute settings a quick turnaround time is also desirable especially in the case of highly infectious diseases like C. difficile infection where a quarantine might be required. However, even in the doctor's office or retail clinic it is highly beneficial to determine if a condition is viral or bacterial prior to administering antibiotics.

With some disease conditions the concentration of the biomarker or analyte of interest is relatively high and simple low-cost lateral flow devices may be employed for sample processing and readout. These devices and the consumable components that interact with the sample are very low cost and can be used quickly with relatively little or no training at the point-of-care. However, lateral flow type tests also tend to suffer from poor precision making quantitative measurements of marginal quality even if an objective reader system is used to measure the strips. Also, depending on the stage of a disease or infection the concentration of the target analyte is often too low to detect with lateral flow in the blood, urine, saliva or other sample types.

In these cases the sample processing and readout is more complex. It often requires precise metering to assess concentration, high efficiency to avoid loss of the target analyte and centrifugal separation as a primary step in the purification process. Beyond centrifugation, additional purification steps typically include incubation with reagents containing binding partners or molecules with complimentary sequences or structures to bind to the target analyte biomarker. These binding partners may be substrates such as micro- or nanoparticles with complimentary molecules on their surfaces or molecules conjugated to transduction labels, or both. Once binding occurs additional process steps must then be taken to wash and further isolate the target analyte to suspend it in pristine buffer solution or lay it down on a clean surface prior to measurement. To perform these processing steps, multiple devices including centrifuges, mixers, incubators, precision pipettors, and thermal cyclers are used wherein the sample is often transferred and metered between the processing steps with multiple disposable tips, tubes, plates and other sample containers etc. Once the processing is complete highly sensitive and highly precise instruments are used to measure the processed sample to determine the presence and or abundance of the target analyte.

While the analysis of low concentration biomarkers may take several forms, in general the processing and measurement of the sample has the following principal characteristics:
1. A separation step to perform a first isolation of the target analyte from other sample components
2. Introduction of binding partners and reagents
3. Mixing and incubation to label and bind target analytes to a substrate
4. Introduction of buffers and steps to wash away unbound labels and other contaminates
5. Sterile containers for precise metering and sample containment during processing
6. An efficient and precise means of sample transfer
7. A means of measurement providing high sensitivity and precision to determine the presence and abundance of the target analyte.

At present the processing and measurement of low concentration biomarkers must be done by trained staff or with the use of highly specialized equipment in centralized locations. Consequently, the turn-around time from sample acquisition to result is long, the instrumentation cost is high, and the measurement cannot be done at the point-of-care.

Accordingly, the present inventors have recognized that an improved technique that can address the principal characteristics listed above for low concentration biomarker processing and measurement is desired. The technique should be suitable for the point-of-care environment with minimal consumables, precise metering, fast turnaround time, and with sensitivity that overcomes the limitations of the prior art.

U.S. Pat. No. 8,264,684, and U.S. Patent Application Publication No. 2016/0178520, each of which is incorporated herein by reference, describe previous systems that achieved extremely sensitive detection. The disclosure provides further development in this field.

### SUMMARY

Disclosed herein are analyzer systems, cartridges, and methods for detection of a target analyte of a sample. Beneficially, embodiments of the analyzer system use a compact cartridge to process and analyze the sample, which allows the analyzer to be of a reduced size so that it can be provided at the point of care.

Thus, in a first aspect, the present disclosure provides an analyzer system for detecting the presence of a target analyte in a sample, the analyzer system comprising:
a motor;
a dock coupled to the motor so as to be rotated by actuation of the motor;
a cartridge held in the dock and including a fluid circuit configured to receive a sample, isolate a target analyte of the sample, and collect a quantity of a first label that is proportional to a quantity of the target analyte in the sample, the fluid circuit including:
   a sample port configured to receive a sample,
   a mixing chamber in fluid communication with the sample port and configured to mix at least a portion of the sample so as to bind the target analyte with the first label, and
   a fluid inlet port in fluid communication with the mixing chamber and configured to receive wash buffer and elution buffer,
   wherein the fluid circuit includes an isolated path extending from the fluid inlet port to the mixing chamber;
a fluid delivery line configured to be coupled to the fluid inlet port so as to deliver fluid to the cartridge through the fluid inlet port and push the fluid along the isolated path toward the mixing chamber;
a first magnet secured on a stage that is movable with respect to the cartridge and configured to move paramagnetic beads within the cartridge;
a first electromagnetic radiation source configured to provide electromagnetic radiation to form an interrogation space within a detection chamber of the cartridge;
a first detector configured to detect electromagnetic radiation emitted in the interrogation space by a label if the label is present in the interrogation space; and
a controller configured to identify the presence of the target analyte in the sample based on the electromagnetic radiation detected by the first detector.

In another aspect, the disclosure provides a method comprising:
receiving a cartridge in an analyzer system such that the cartridge is coupled to a motor of the analyzer system;
rotating the cartridge using the motor so as to move a volume of a sample to a mixing chamber in the cartridge;
mixing the volume of the sample in the mixing chamber by moving the cartridge so as to bind the target analyte and a label to paramagnetic capture beads;
introducing a series of fluids from a primed fluid delivery line into the cartridge through a fluid inlet port, the series of fluids including wash buffer and elution buffer; pushing the series of fluids along an isolated path in a first direction from the fluid inlet port to the mixing chamber;
using a magnet, moving the paramagnetic capture beads out of the mixing chamber along the isolated path in a second direction toward the fluid inlet port.

This as well as other aspects, advantages, and alternatives, will become apparent to those of ordinary skill in the art by reading the following detailed description.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic perspective side view of a high sensitivity analyzer according to an embodiment of the disclosure;

FIG. 2 is a schematic perspective top view of the analyzer of FIG. 1;

FIG. 3 is a schematic perspective view of a processing quality control camera optical system used in the analyzer of FIG. 1;

FIG. 4 is a schematic perspective view of a portion of the analyzer of FIG. 1 including a centrifuge, objective lens and objective radial and Z stages;

FIG. 5 is a schematic perspective side view of a portion of the analyzer of FIG. 1 including a manifold and the cartridge;

FIG. 6 is a schematic perspective bottom view of the manifold of FIG. 5;

FIG. 7 is a schematic side view of a portion of the analyzer of FIG. 1 including an objective;

FIG. 8 is a schematic depiction of a fluid system of the analyzer of FIG. 1

FIG. 9 is a schematic view of a pump, primed fluidic line along with a pump purge line and valve in accordance with an embodiment of the disclosure;

FIG. 10 is a schematic top view of a cartridge including several fluid circuits in accordance with an embodiment of the disclosure;

FIG. 11 is a schematic top view of a fluid circuit of the cartridge of FIG. 10 at a first instance of a method according to an embodiment of the disclosure;

FIG. 12 is a schematic top view of the fluid circuit of FIG. 11 at a second instance of a method according to an embodiment of the disclosure;

FIG. 13 is a schematic top view of the fluid circuit of FIG. 11 at a third instance of a method according to an embodiment of the disclosure;

FIG. 14 is a schematic top view of the fluid circuit of FIG. 11 at a fourth instance of a method according to an embodiment of the disclosure;

FIG. 15 is a schematic top view of the fluid circuit of FIG. 11 at a fifth instance of a method according to an embodiment of the disclosure;

FIG. 16 is a schematic top view of the fluid circuit of FIG. 11 at a sixth instance of a method according to an embodiment of the disclosure;

FIG. 17 is a schematic top view of the fluid circuit of FIG. 11 at a seventh instance of a method according to an embodiment of the disclosure;

FIG. 18 is a schematic top view of the fluid circuit of FIG. 11 at an eight instance of a method according to an embodiment of the disclosure;

FIG. 19 is a schematic top view of the fluid circuit of FIG. 11 at a ninth instance of a method according to an embodiment of the disclosure;

FIG. 20 is a schematic top view of the fluid circuit of FIG. 11 at a tenth instance of a method according to an embodiment of the disclosure;

FIG. 21 is a schematic top view of the fluid circuit of FIG. 11 at an eleventh instance of a method according to an embodiment of the disclosure;

FIG. 21 is a schematic top view of the fluid circuit of FIG. 11 at a twelfth instance of a method according to an embodiment of the disclosure;

FIG. 22 is a schematic top view of the fluid circuit of FIG. 11 at a thirteenth instance of a method according to an embodiment of the disclosure;

FIG. 23 is a schematic top view of a fluid circuit in accordance with another embodiment of the disclosure;

FIG. 24 is a schematic side view of a portion of the analyzer of FIG. 1 including magnetic stages;

FIG. 25 is a schematic side view of various steps in a washing operating utilizing magnets in accordance with an embodiment of the disclosure;

FIG. 26 is a schematic side view of various steps in another washing operation utilizing magnets in accordance with an embodiment of the disclosure;

FIG. 27 shows data from a read process carried out by an analyzer in accordance with an embodiment of the disclosure;

FIG. 28 is a schematic top view of a fluid circuit in accordance with another embodiment of the disclosure; and

FIG. 29 is schematic top view of a fluid circuit in accordance with yet another embodiment of the disclosure.

FIG. 30 is a schematic top view of a fluid circuit in accordance with another embodiment of the disclosure.

FIG. 31 is a schematic top view of a fluid circuit in accordance with still another embodiment of the disclosure.

FIG. 32 is schematic fop view of a cartridge including several fluid circuits of FIG. 31.

FIG. 33 shows a system including the cartridge of FIG. 32 and a magnetic carrier.

FIG. 34 is a schematic top view of a cartridge in accordance with another embodiment of the disclosure.

FIG. 35 is a schematic top view of a cartridge in accordance with yet another embodiment of the disclosure.

### DESCRIPTION

The following detailed description presents an overview of an example embodiment of a method and system according to the invention. This overview is followed by further descriptions of various example embodiments of methods, systems and apparatuses in connection with the invention.

### Overview of an Example Embodiment

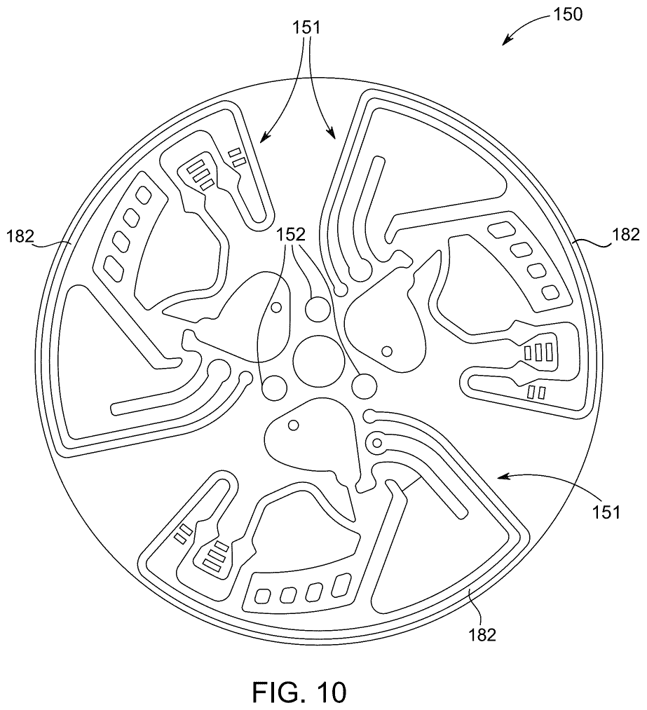

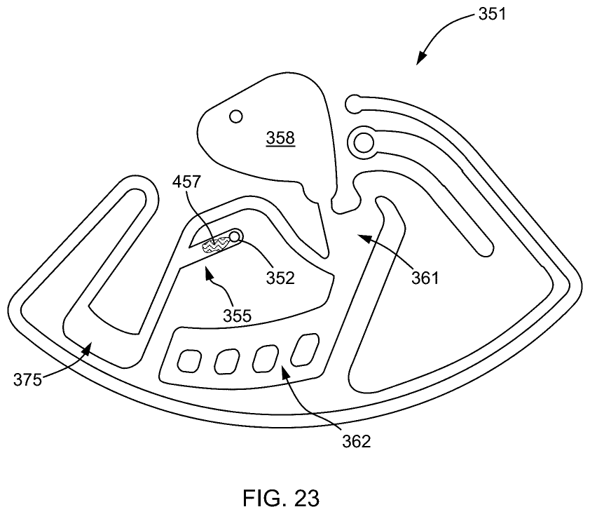

The present invention is directed to a sample processing and analysis system to isolate target analytes and determine their concentration. The systems and methods described herein use a cartridge, in the form of a single consumable disc, that is coupled to a centrifuge. However, aspects of the disclosure may also be achieved using other containers and sample processing configurations. Furthermore, while the following example uses a cartridge with a fluid circuit having a particular configuration (FIGS. 10-22), other fluid circuit configurations are also possible (e.g., FIGS. 23, 28-31), as described further below.

The cartridge may include various chambers and passages for receiving and processing a sample. As the sample is processed, analytes and labels may be directed through the cartridge so as to pass through various different zones in the cartridge. These zones may be delimited by structural features, such as a narrow passage between two larger chambers, or may be different areas within the cartridge that can contain a fluid. For example, an elongate chamber that is formed by a channel may provide several functional zones as constituents of the sample are moved along the length of the chamber.

### Separation and Metering

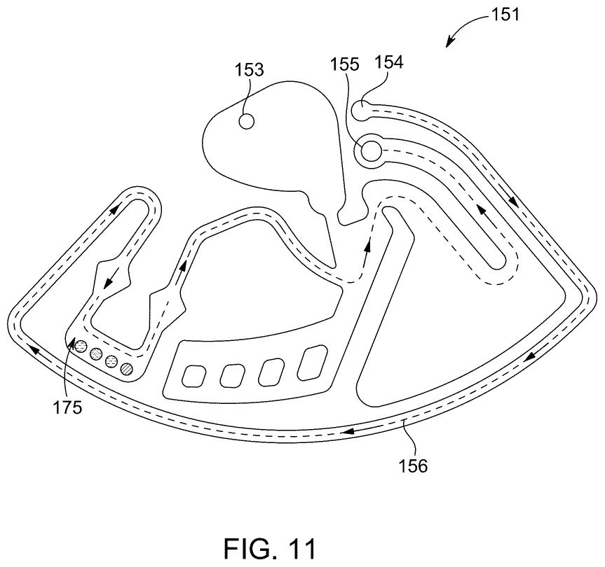

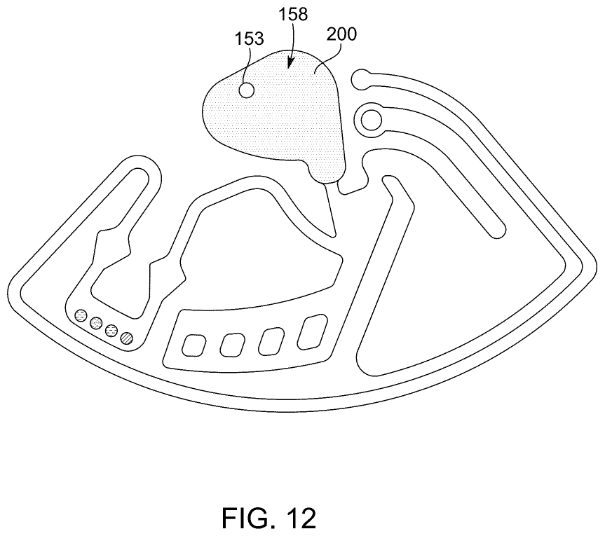

FIG. 10 shows a cartridge 150 with three fluid circuits 151 which may be used for all sample processing, metering and containment of the resulting processed sample during measurement. Each of the fluid circuits 151 may receive a separate sample for processing and analysis. A more detailed view of one of the fluid circuits 151 is shown in FIG. 11. FIGS. 12-22 illustrate a sequence of steps in the processing of a sample in one of the fluid circuits 151 of the cartridge 150 shown in FIG. 10. In the illustrated embodiment, the processing involves high speed spinning of the disc to spin down dense elements contained in the original sample. As shown in FIG. 11, the fluid circuit 151 includes a sample port 153 for receiving a sample, an inlet port 154 for receiving various solutions for processing the sample, and a vent port 155. In view of the use of one inlet port 154 and one vent port 155, the circuit 151 includes a single flow path 156 along which fluids introduced through the inlet port 154 progress toward the vent port 155 during processing. As explained in more detail below, in certain embodiments this path may be isolated at least from the mixing chamber 175 to the input port 154, which simplifies processing.

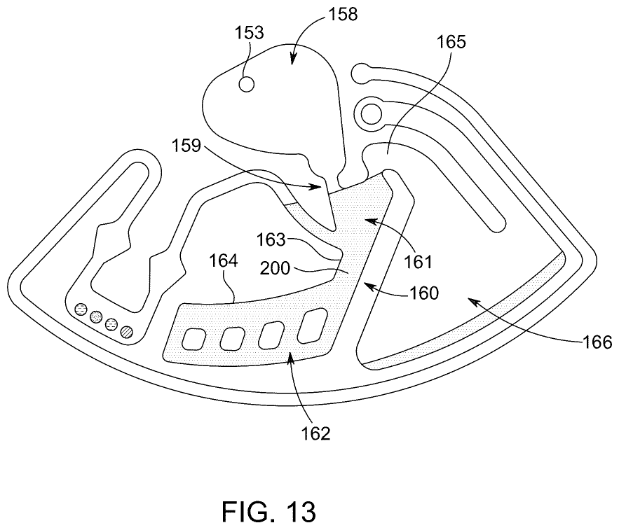

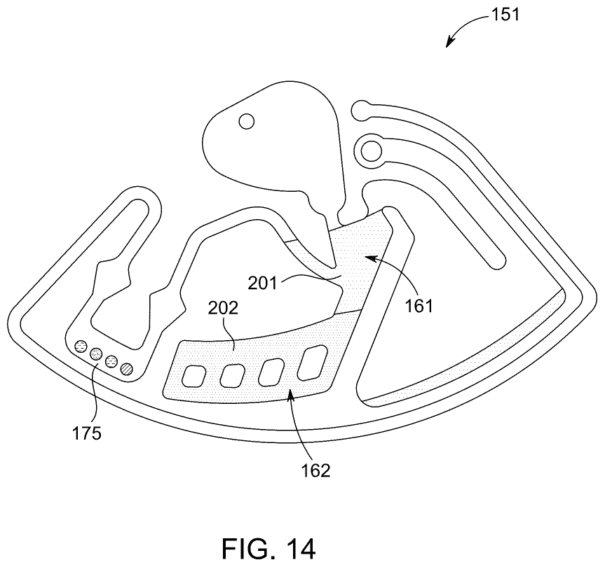

During the initial centrifugation step as shown in FIG. 13, the sample 200 is transferred from a sample chamber 158 to inner and outer separation areas 161, 162. The cartridge 150 is then spun at a higher speed, for example 7000 rpm, to separate dense elements into outer separation area 162, as shown in FIG. 14. The resulting supernatant in inner separation area 161 is then transferred to a mixing chamber 175 containing reagents composed of binding partners. The volumes of the inner separation chamber 161 and mixing chamber 175, as well as the method of the transfer of the supernatant, act to meter the amount of sample used in processing in order to maintain precision. The spin down process and transfer may be imaged by a processing quality control camera and analyzed during processing to ensure proper separation and metering.

### Reagents and Binding Partners

Various binding partners may be used in accordance with embodiments of the disclosure. For example, a first species may be paramagnetic bead substrates that are functionalized with molecules that have binding sites specific to the target analyte. A second species of binding partner may include labels conjugated to molecules with binding sites specific to a separate but distinct portion of the target analyte. A third and fourth species of binding partners may be used as a control assay which include a second set of functionalized paramagnetic bead substrates and a second set of fluorescent labels emitting at a different wavelength than the first set of fluorescent labels. The third and fourth species are designed to bind to each other. Since these species undergo the same assay process, and the amount of the third species is known a priori, it can serve as a control assay to monitor of the efficacy of the sample processing and measurement.

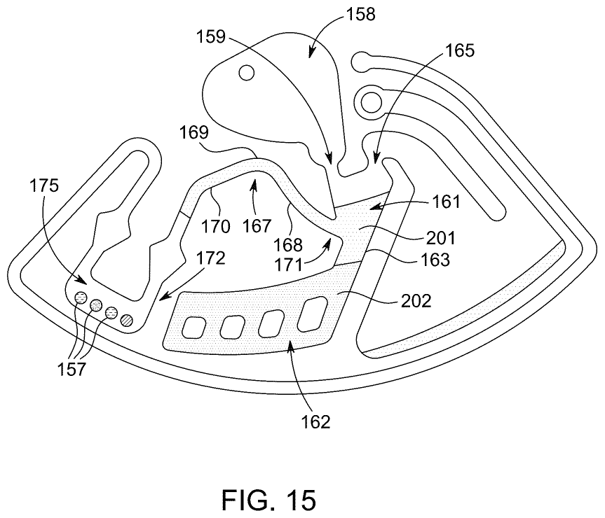

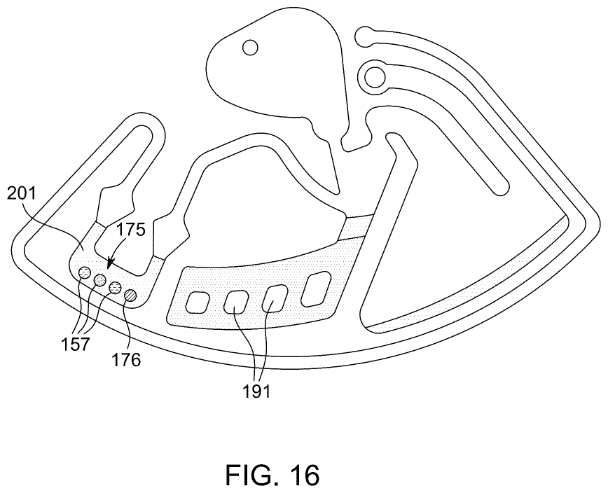

In some embodiments the binding partners may be loaded in the cartridge in advance. For example, the binding partners may be in the form of dried reagents or lyophilized pellets 157 identified in FIGS. 15 and 16, and may be stored in the mixing chamber. The lyophilized pellets 157 may contain multiple species of binding partners.

In other embodiments, the cartridge may be configured to receive binding partners at the time of processing. For example, FIG. 23 shows an embodiment of a fluid circuit 351 including a port 352 for receiving binding partners. The port 352 allows liquid reagents 457 to be introduced into the fluid circuit 351 prior to or during an analysis procedure. In the illustrated embodiment, the port 352 is radially interior to the mixing chamber 375, such that rotation of the associated cartridge will drive the liquid reagents 457 into the mixing chamber 375. Such an embodiment, which allows for the introduction of liquid reagents, may enable general use of the cartridge of the disclosure. Rather than storing assay-specific lyophilized pellets, the cartridge may receive user-selected liquid reagents through the port 352. Accordingly, such an embodiment enables the user to input application-specific binding partners contained in the liquid reagents 457 at the time of use.

### Mixing and Incubation

Once the supernatant and reagents are in the mixing chamber, a mixing process will occur in which the disc 150 will spin slowly, but at a variable rpm. Specifically, the disc will accelerate and decelerate rotationally at a controlled rate to execute a preferred motion profile during the spin. As shown in FIG. 16 a mixing ball 176 of higher density than the sample, such as brass or glass, may also be incorporated in the mixing chamber. Beneficially, the acceleration and deceleration of the cartridge will induce the ball to move through the supernatant to facilitate dissolving and disbursement of the dried reagents and ensure a homogeneous mixture of all reagents and the target analyte. The mixing chamber geometry may be configured along a substantially constant radius from the center of rotation. Moreover, this chamber may contain various features to further facilitate mixing and incubation and to ensure the mixture stays in the mixing chamber during the mixing process. The result of the mixing process will promote a homogeneous suspension to facilitate binding of the target analyte to the paramagnetic capture beads and labeled molecules. To ensure precision, the mixing process can be carried out for a controlled amount of time.

The flow path 156 passes through the mixing chamber 175 via two channels 173 and 174 that each extend radially inward from the mixing chamber 175. One or both of these channels may contain capillary breaks 178, 179 in the form of flared channel widths, as identified in FIG. 16, to prevent capillary action from pulling the sample out of the chamber after it has been transferred and while the cartridge is not spinning. During mixing and incubation, when the cartridge is rotated and alternately accelerated and decelerated these channels keep the sample in the mix chamber via centrifugal force. An elbow 180 at the end of the post mixing chamber channel 174 reverses direction to a radial channel 181 extending outward towards a circumferential channel 182. As described below washing may occur in zones included in any of the mix chamber 175 or the channels 173, 174, 181, 182.

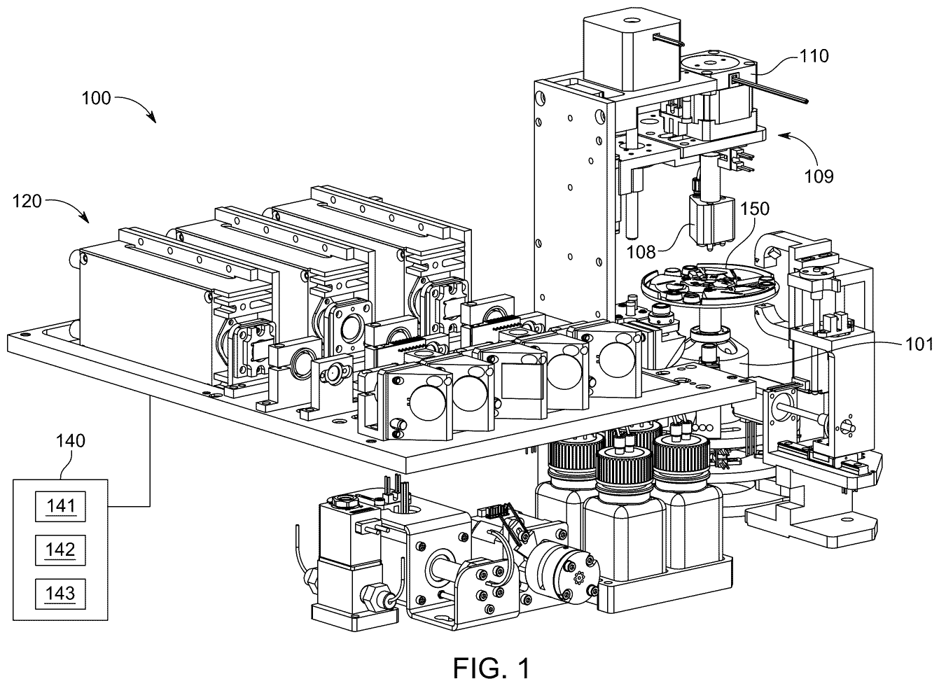

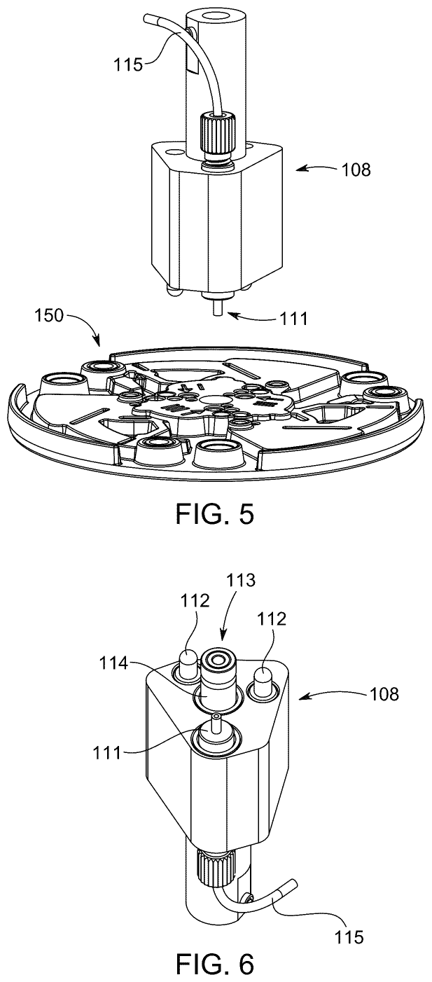

Once the mix and incubation processes are complete, the cartridge 150 and manifold 108 (FIG. 5) may be rotated into alignment to enable the fluidic line 111 (FIG. 5) on the manifold 108 to interface with the inlet port 154 (FIG. 11) on the cartridge. The manifold may be coupled to a motor 110 for precision rotary movement. The manifold may also be on a moveable arm 109 as shown in FIG. 1 to lower and raise the manifold to and from the cartridge. Once the manifold is registered and in contact with the cartridge, the manifold motor enables precise rotary motion of the cartridge 150 about the axis of the centrifuge motor. At this point the centrifuge motor may be de-energized and its bearings and shaft can serve as a precision rotary stage for the cartridge.

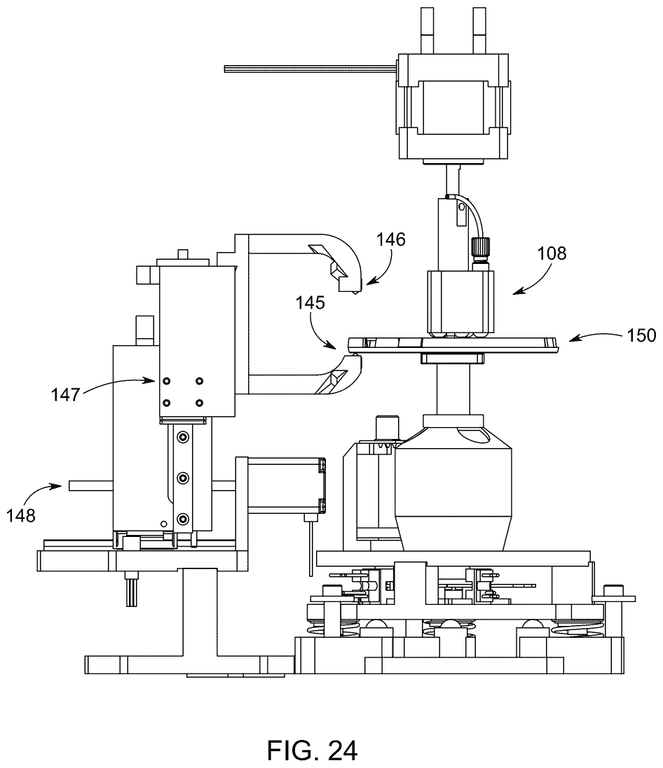

After the manifold 108 is registered on the cartridge 150, one or more magnets are moved into position over the mixing chamber. The magnets may be positioned above and below the cartridge on a Z-stage with an axis of motion perpendicular to the flat surface of the cartridge as shown in FIG. 24. This enables magnet 145 to move closer to the cartridge 150 increasing its effective pull on the paramagnetic capture beads while the other magnet 146 moves away from the cartridge 150 decreasing its affect. The magnet Z-stage 147 is also coupled to a radial stage 148. The radial stage allows movement of the magnets closer to or away from the axis of rotation of the cartridge. As discussed later, various channels and chambers on the cartridge are nominally arranged radially or circumferentially. The various Z- and radial stages in combination with the manifold motor enable the magnets to be placed at any desired position relative to the chambers and channels contained within the cartridge 150.

After one or more magnets are introduced, the magnet Z- and radial stages are controlled along with partial cartridge rotation to execute a predefined sequence of movements to pull all the paramagnetic capture beads which are now binding the target analyte and control labels out of suspension as shown in FIG. 18. The magnet 145 on the bottom side of the cartridge is brought into proximity of the surface of the cartridge in a preferred location to pull the beads into a tight bolus 177 in FIG. 18. The bead bolus may be imaged by a processing quality control camera and analyzed to ensure the beads have been properly pulled from suspension.

### Introduction of Wash Buffers and Washing

At this point fluids are introduced into the fluid circuit 151 from the manifold 108 through the inlet port 154. In some embodiments, the fluids may be introduced from a preloaded line including precise volumes of the fluids being introduced. As explained below, by preloading a line with the fluids needed for processing, a single pump may be used to quickly and efficiently direct all the fluids through the fluid circuit 151.

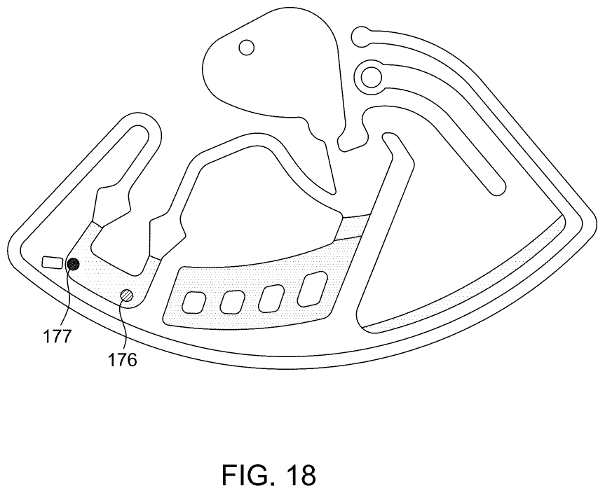

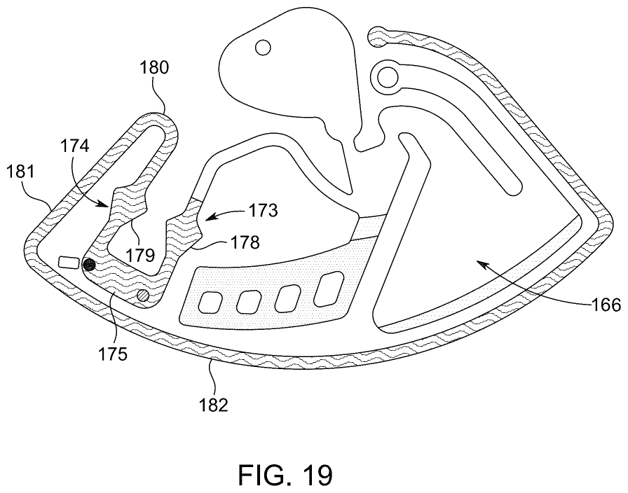

With the magnet holding the analyte bead bolus in place the pump pushes wash buffer 270 through the inlet port 154 into the fluid circuit 151 and fills circumferential channel 182, radial channel 181, elbow 180, post mixing chamber channel 174, mixing chamber 175, and ante mixing chamber channel 173 with wash buffer as shown in FIG. 19.

This pushes the sample fluid and unbound label out of the mix chamber 175, thereby beginning the wash process. Wash buffer flowing over the bolus containing analyte washes unbound labels within the bolus out of the bolus and continues to do so as wash buffer flows over the bolus and out of the mix chamber 175 towards the waste chamber 166. Aside from the capillary breaks 178, 179, the channels 172, 173, 180, 181, 182 have a generally consistent cross sectional area with few discontinuities or abrupt corners. This geometry facilitates filling with buffers leaving no air pockets behind that can impede the subsequent wash, elution and read processes.

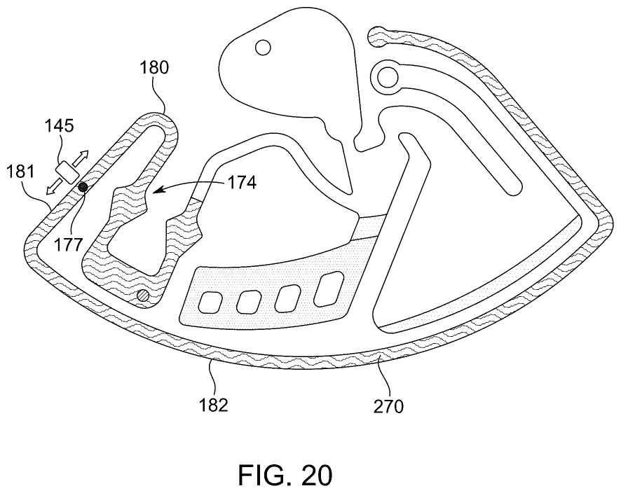

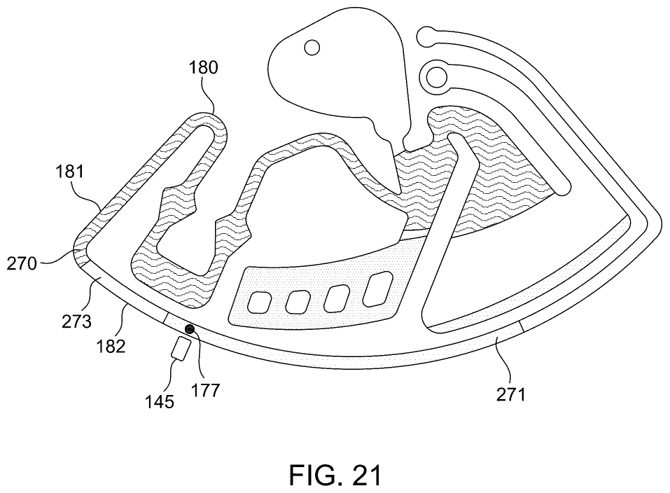

Once the initial wash buffer fill is complete a further wash sequence can begin. This can be done with a single magnet by dragging the bolus back and forth in the mix chamber or dragging the bolus into post mixing chamber channel 174, around elbow 180, as shown in FIG. 20 and down through radial channel 181 to circumferential channel 182 as shown in FIG. 21. During the drag through channels 174, 180 and 181, the bolus may be continuously exposed to clean wash buffer and therefore washing away unbound labels and non-specifically bound labels. If needed further washing can be implemented via the use of a second magnet, as described in more detail below.

Elution of Analyte and Label from Paramagnetic Beads

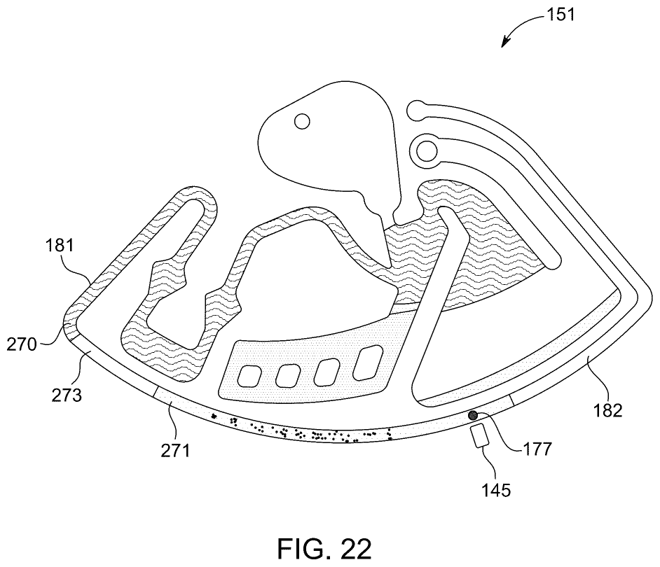

To begin elution the bead bolus may be moved, for example, to a predefined zone in the circumferential channel 182, as shown in FIG. 21, that is clean and has not been exposed to any assay components. At this point the pump 118 pumps the leading air separator 273 between the wash buffer 270 and elution buffers 271 through inlet port 154, into circumferential channel 182 and over the bead bolus to a predefined position beyond the bolus in circumferential channel 182 as shown in FIG. 22. The second air separator 273 between the bolus and the DI water 272 will be on the side of the bolus closer to the inlet port 154, thereby providing a region of elution buffer in which to elute the target analyte and labels for ultimate reading of the sample to enumerate the number of target analyte molecules present.

Once the elution buffer is in position a sequence of magnet movements similar to the wash sequence can be initiated to pull the bead bolus up and down across the circumferential channel 182 exposing individual beads to the elution buffer which will cleave the bonds between the analyte and paramagnetic bead leaving behind analyte and label in suspension within the slug of elution buffer between the air separators as shown in FIG. 22. The paramagnetic beads will follow the path of the magnetic field as the magnets are moved. Ultimately, the bolus can be recondensed in the channel and dragged away from the elution zone leaving a space between the bolus and elution zone containing the label that was bound to the analyte of interest as shown in FIG. 22.

### Measurement

In the measurement step, a confocal laser-based optical system is focused within the elution chamber, for example at a point in the elution chamber away from the walls, upper and lower surfaces of the chamber. Measurement and detection of analyte occurs in an elution chamber formed by the circumferential channel 182, therefore the circumferential channel serves as both the elution chamber and the detection chamber.

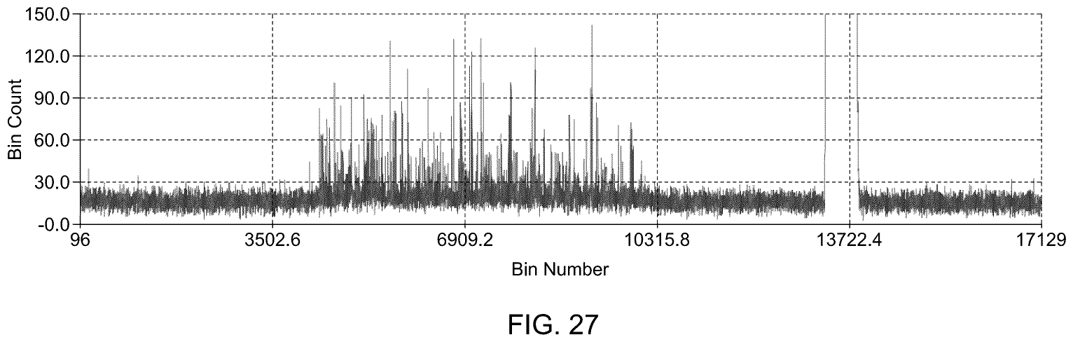

The cartridge itself may be made of ultra-low autofluorescence material and the elution buffer, pump materials, valves, fluidic lines etc. may be selected such that they do not shed or leach materials which might autofluoresce if carried into the elution chamber. A small interrogation space is scanned through the liquid in the elution chamber by spinning the cartridge at a predefined rpm back and forth via the manifold motor. The interrogation space is defined by the lateral extent of the laser spot and the lateral extent of the cone angle of light forming the laser spot. The interrogation space is further defined along the optic axis by the size of the confocal stop positioned conjugate to the field in the optical system. As those skilled in the art will appreciate a confocal architecture is used to remove light from positions away from the focal plane. The further away from the focal plane and the smaller the confocal stop, the more the light coming from distant positions is attenuated. In imaging applications, this reduction in out-of-focus light reduces noise and provides crisp image slices. Light coming from positions away from the focal plane (or image slice) does not represent the structure in the image slice and is therefore noise. The same process of noise reduction may be employed in the present invention; however, in this case the confocal system is not used for imaging. As the laser spot scans through the fluid it may encounter a fluorescent label from the target analyte. When it does, the laser excites fluorescence from the label and individual photons are emitted from the label and directed by the optical system on to a detector where they are counted. On the way to the focal plane, and beyond the focal plane, the laser light may encounter elements that autofluoresce, including the glasses and bonding materials that comprise the optical system, the window on the cartridge, the back side of the cartridge forming the elution chamber, or the elution buffer itself. Any fluorescence from those components is noise since it is not from a target analyte label. The confocal architecture attenuates those signals by preferentially allowing signal from target analyte labels in or near the focal plane. As a result, when the laser passes over a target label, the stream of photons received and counted by the detector increases over the background photon level as shown in FIG. 27 and described in further detail below. Processing algorithms detect and classify the elevated photon count as a molecule of interest. In this manner individual molecules from the target analyte can be counted to determine a concentration of the target analyte in the original sample.

The present disclosure enables substantial advantages over the prior art to precisely detect and quantify the number of target analytes in a sample wherein the concentration of target analytes in the sample is low. Further, the methods and systems of the present disclosure have characteristics suitable for deployment in a point-of-care setting. Other aspects of the present disclosure are directed towards methods of sample processing and analysis to isolate target analytes and determine their concentration. These methods implement steps that are generally consistent with the sample processing and measurement above.

### EXAMPLE EMBODIMENTS

Examples and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment,” “an embodiment,” “one example,” or “an example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

### Example Analyzer System

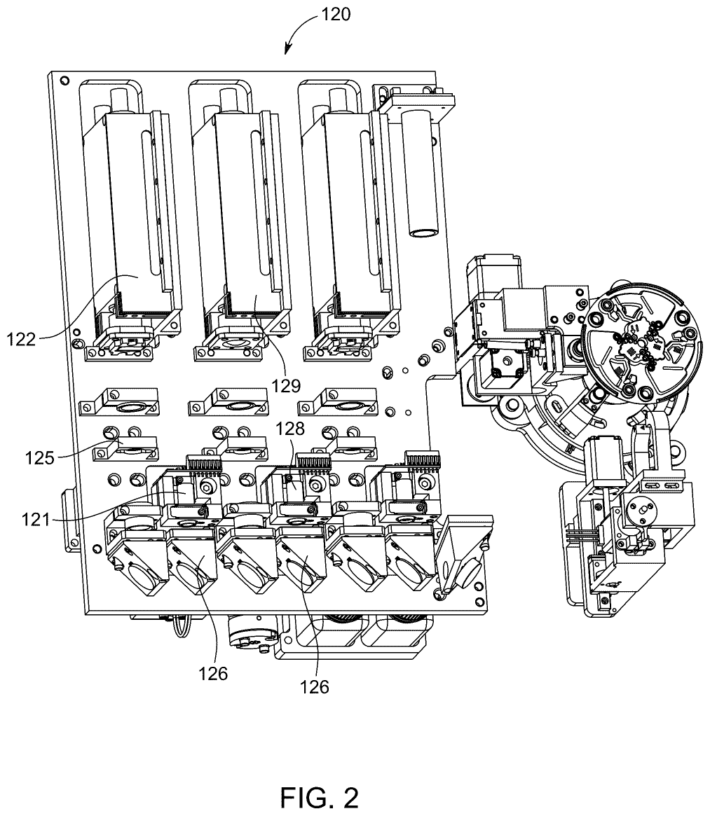

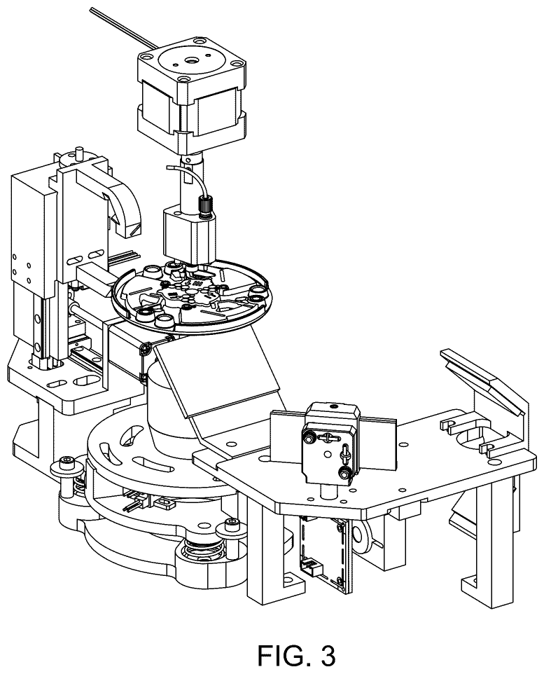

In one aspect, the disclosure provides an analyzer system, such as that shown in FIG. 1, which includes an analyzer 100 and a cartridge 150. The cartridge 150 is configured to receive a sample and includes a plurality of chambers for isolating a target analyte of the sample and collecting a quantity of a first label that is proportional to a quantity of the target analyte in the sample. The analyzer 100 includes an optical system 120. Components of the optical system 120 are shown separately from other parts of the analyzer in FIG. 2, for clarity. As shown, optical system 120 includes an electromagnetic radiation source 121 configured to provide electromagnetic radiation to form an interrogation space within a detection chamber of the cartridge 150. The optical system 120 also includes a detector 122 configured to detect electromagnetic radiation emitted in the interrogation space by the first label if the first label is present in the interrogation space. Other components of the optical system 120 are described in more detail below.

Analyzer 100 also includes a controller 140, which is schematically represented in FIG. 1. The controller 140 includes a non-transitory computer-readable medium with program instructions stored thereon for carrying out the steps conducted by the analyzer 100 and identifies the presence of the target analyte in the sample based on the electromagnetic radiation detected by the detector 122. Controller 140 includes a processor 141, a memory 142, and a network interface 143.

Processor 141 of controller 140 includes a computer processing elements, e.g., a central processing unit (CPU), an integrated circuit that performs processor operations, a digital signal processor (DSP), or a network processor. In some embodiments, the processor includes register memory that temporarily stores instructions being executed and corresponding data, as well as cache memory that temporarily stores performed instructions. Memory 142 is a computer-usable memory, e.g., random access memory (RAM), read-only memory (ROM), or non-volatile memory such as flash memory, solid state drives, or hard-disk drives. In some embodiments, memory 142 stores program instructions that are executable by controller 140 for carrying out the methods and operations of the disclosure. Network interface 143 provides digital communication between controller 140 and other computing systems or devices. In some embodiments, the network interface operates via a physical wired connection, such as an ethernet connection. In other embodiments, the network interface communicates via a wireless connection, e.g., IEEE 802.11 (Wifi) or BLUETOOTH. Other communication conventions are also possible.

In some embodiments, the analyzer 100 includes at least one motor configured to rotate the cartridge in order to manipulate any sample placed in the cartridge and to align the cartridge with parts of the analyzer. In some embodiments, the motor is a centrifuge drive motor and in other embodiments the motor is a positioning motor. Further, in some embodiments, the analyzer includes both a centrifuge and a positioning motor. For example, analyzer 100, shown in FIG. 1, includes both a centrifuge 101 and a positioning motor 110.

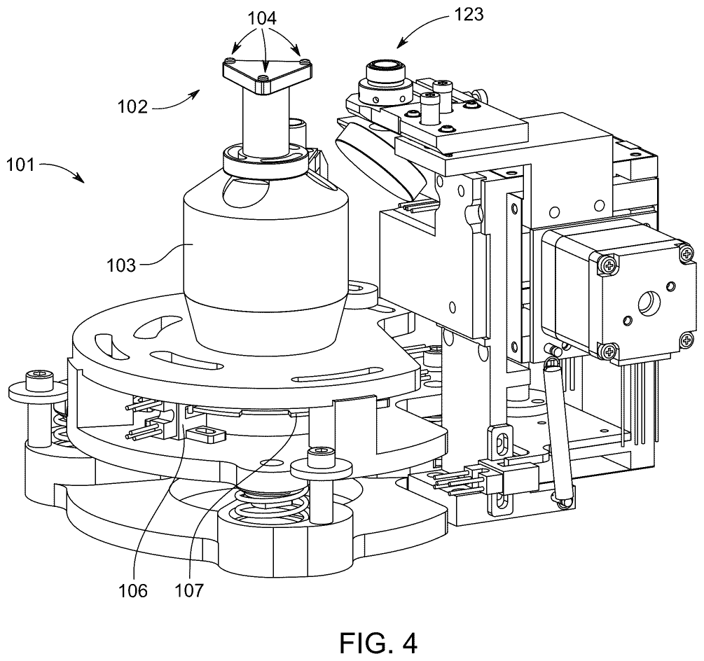

In analyzer 100 the centrifuge 101 is coupled to the cartridge 150 in order to spin the cartridge at a speed of at least 100 rpm. Details of the centrifuge 101 are shown more clearly in FIG. 4. As illustrated, a centrifuge drive motor 103 is configured to couple to the cartridge using a dock 102. The dock shown in FIG. 4 includes a three point kinematic mount 104. The cartridge 150 has corresponding countersunk slots 152 to register and hold the cartridge 150 on the dock 102. Further, the manifold 108 (FIG. 6) may include a bearing 113 on a spring loaded plunger 114 to hold the disc 150 against the dock when the disc 150 is rotated by the centrifuge motor 103. Accordingly, the cartridge 150 may be securely held in the dock 102 when inserted into the analyzer 100.

The dock 102 is connected to the centrifuge drive motor 103 in order to rotate the dock 102 and the cartridge 150 that is attached thereto. Further, the centrifuge drive motor 103 may include electronic drive phase sensors 106 and a flag wheel 107 for high-speed precision control of the centrifuge 101 during operation. In some embodiments, the dock 102 is driven directly by the centrifuge drive motor 103, while in other embodiments, a power transfer system, such as a gearbox or a belt drive, may be used to couple the dock 102 to the centrifuge drive motor 103. As explained below, the dock 102 may also be driven by a manifold 108 (see FIG. 1). Specific embodiments of operations of the centrifuge 101 are described in more detail below.

In some embodiments, the analyzer includes a manifold 108 with one or more ports that are each configured to couple to a respective port of the cartridge. A depiction of the manifold 108 coupled to the cartridge 150 is shown in FIG. 5. Further, a bottom view of the manifold 108 is shown in FIG. 6 to illustrate the fluid line port 111 and the bearing 113 to hold the cartridge 150 to the dock. In order to transfer fluids to the cartridge, the manifold 108 includes a fluidic line 115 that is connected to the port 111.

The fluid line port 111 of the manifold 108 is registered to the cartridge 150 at port 154 and may include a seal that covers the corresponding port of the cartridge 150 in order to isolate the fluid transfer between the manifold 108 and the cartridge 150. For example, fluid line port 111 may include an O-ring or other feature to create a seal between the manifold and cartridge port that surrounds the inlet port of the cartridge 150. In some embodiments, the inlet port of the cartridge 150 is already open when the cartridge 150 is placed in the analyzer. In other embodiments the manifold is configured to pierce the cartridge 150 so as to open the inlet port of the cartridge 150.

In some embodiments, the manifold 108 is disposed on a movable arm 109 (shown in FIG. 1), which allows the manifold 108 to be decoupled from the cartridge 150 when inserting or removing the cartridge 150 from the analyzer. As shown in FIG. 6, a bearing 113 on a plunger holds cartridge 150 on the dock when the cartridge 150 is rotated at high speeds by the centrifuge 101. Coupling of the manifold 108 to the cartridge 150 for rotation via the manifold may be enabled by an alignment structure. For example, as shown in FIG. 6, the manifold 108 may include pins 112 to secure the manifold to the cartridge. When the cartridge 150 is rotated by the manifold 108 the manifold moves down onto the cartridge 150 to engage pins 112 with the cartridge 150 mounting apertures. In other embodiments, pins of the dock 102 may pass through the mounting apertures 152 of the cartridge 150 into receiving holes in the manifold 108. Such a structure provides a secure connection between the manifold 108, the cartridge 150 and the dock 102. Other mounting structures are also possible, as will be appreciated by those of ordinary skill in the art.

In some embodiments, the analyzer 100 includes a positioning motor 110 that is coupled to the cartridge 150. In some embodiments the positioning motor 110 may be coupled to the manifold 108 which couples to the cartridge 150. The positioning motor 110 may be configured to pivot the cartridge 150 so as to align the circumferential channel 182 (see FIG. 11) of a fluid circuit 151 of the cartridge 150 with the electromagnetic radiation passing through objective lens 123 (FIG. 1) from the first electromagnetic radiation source 121 (FIG. 2). Moreover, the positioning motor 110, in concert with one or more magnets, or by the fluid dynamics of the sample, may further be used to circulate the target analytes through the chambers of the cartridge 150, as described in more detail below. The positioning motor 110 may be a stepper motor or another actuator with specific positioning control. For example, in some embodiments, the location of the positioning motor 110 may be specified to within 2° of rotation, or within 1° of rotation, or smaller than 1° increments. Specific examples of embodiments of using the positioning motor 110 are described in more detail below.

In some embodiments, the positioning motor 110 is directly coupled to the manifold 108, while in other embodiments, a power transfer system, such as a gearbox or a belt drive, may be disposed between the positioning motor 110 and the manifold 108. In the analyzer 100 shown in FIG. 1, the positioning motor 110 is coupled to the cartridge 150 via the manifold 108. In particular, manifold 108 is disposed on the shaft of the positioning motor 110. Accordingly, the manifold 108 and cartridge 150 may move synchronously while maintaining a closed fluid connection therebetween.

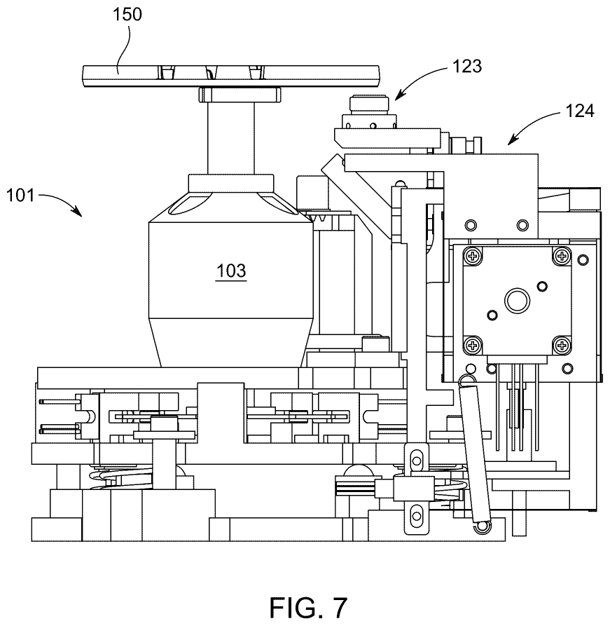

In some embodiments, the analyzer 100 includes an optical system 120 (FIG. 2) that directs the electromagnetic radiation from the first electromagnetic radiation source 121 to the circumferential channel 182 of the cartridge 150, and then collects the electromagnetic radiation emitted by the label to the first detector 122. The optical system 120 may include one or more mirrors and lenses to manipulate and direct the electromagnetic radiation to and from the interrogation space. In addition, the optical system may include an objective 123, as shown in FIG. 7, for focusing the electromagnetic radiation from the first electromagnetic radiation source to the interrogation space in the cartridge 150. In some embodiments, the objective 123 is coupled to a movable stage 124, which allows movement of the objective with respect to the cartridge 150.

In some embodiments, the optical system 120 is a confocal system. For example, the electromagnetic radiation source 121 is imaged as a spot in the focal plane of the objective lens 123 within the circumferential channel 182. Light emitted from a label in the circumferential channel 182 excited by the electromagnetic radiation source 121 is collected by objective lens 123 and directed by the optical system 120 onto a confocal stop 125 in the optical system 120, as shown in FIG. 2. The confocal stop 125 is then imaged onto the detector 122. The confocal arrangement preferentially passes light from the label in the focal plane of the objective 123 while excluding light from beyond the focal plane. In this manner the arrangement increases the signal to noise ratio by passing signal from the label while excluding light from elements in the liquid suspension, cartridge and optical system that are not originating from the label. As is known to those skilled in the art, this arrangement may also use a dichroic filters 126 to reflect laser light and pass light emitted by the label to only allow light from the label to reach the detector while prohibiting laser light from reaching the detector. Further, if more than one radiation source is used for detection of additional labels than one or more additional dichroic filters 126 may be used to reflect laser and label electromagnetic radiation from the first electromagnetic radiation source and label while passing electromagnetic radiation from a second electromagnetic radiation source and second label as shown in FIG. 2. FIG. 2 shows a three channel optical system with a dichroic filter 126 on each laser and a second dichroic filter (or mirror) on each collection channel.

In some embodiments all of the components of the analyzer 100 are disposed in a common housing. The common housing may be small in size, so as to fit on a countertop. For example, in some embodiments, the dimensions of the common housing are no greater than 1 meter in any direction. Further, in some embodiments, the common housing fits within a 30 inch×30 inch×30 inch cube.

In some embodiments the controller 140 includes a network interface 143 for receiving control information from a user and for outputting analysis data to the user. For example, in some embodiments, the analyzer communicates with a user via software on an external device, such as a smartphone, table, notebook computer, or desktop computer. The analyzer receives information from and outputs information to the user of the external device by communicating with the external device via the network interface. Such communication may be through a wireless or wired connection, such as a USB or other bus. In some embodiments, the analyzer 100 may include an input and/or output devices for communicating directly with a user, such as a keyboard for receiving inputs and a display for outputting information. Moreover, in some embodiments the display may include a touchscreen for both outputting information and receiving information from a user. In some embodiments the analyzer includes a network interface, an input, and a display.

In some embodiments the method of the disclosure includes directing portions of the sample through zones of the cartridge 150, including chambers and channels, without the cartridge 150 including any valves. Further, in some embodiments, the cartridge 150 is free of any valves.

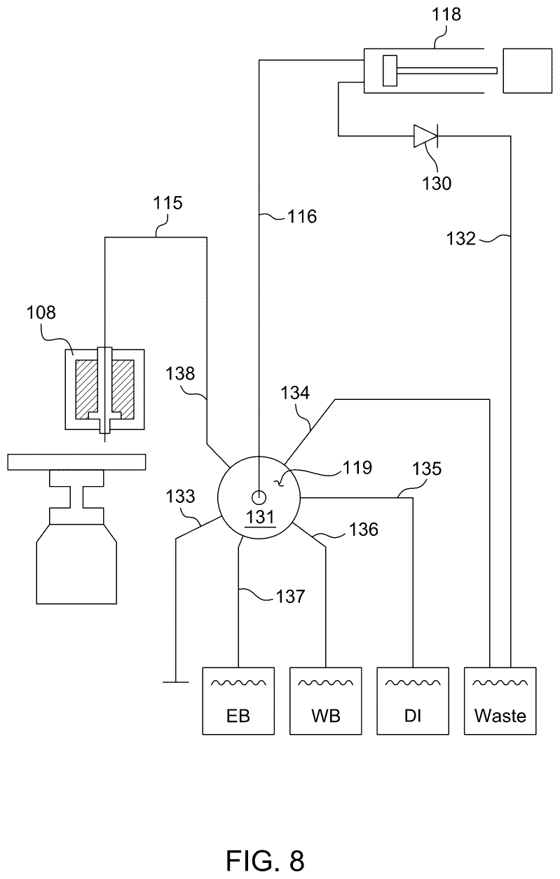

In some embodiments, liquids within the cartridge 150 are, at least in part, moved through the cartridge using a pump and valve coupled to the inlet port of the cartridge, as described in more detail below. For example, in the illustrated embodiment, a pump 118 is used to pre-fill a priming line 116 with various fluids in desired quantities and a desired order, which are then pumped into the cartridge 150 in a sequence. An embodiment of such a pump configuration is shown in FIG. 8.

The pump 118, shown in FIG. 8 is connected to the input port 131 of a distribution valve 119. Various distribution ports on the valve are connected to an air vent port 133, a waste container port 134, a DI water port 135, a wash buffer port 136, an elution buffer port 137 and a manifold port 138. To prepare for buffer injection into the cartridge the distribution valve 119 moves to a position between distribution ports to block the input port 131. While the input port 131 is blocked, a solenoid valve 130 positioned between the pump 118 and a waste chamber 139 opens allowing the pump 118 to empty and dump any contents to the waste chamber 139 via a waste line 132.

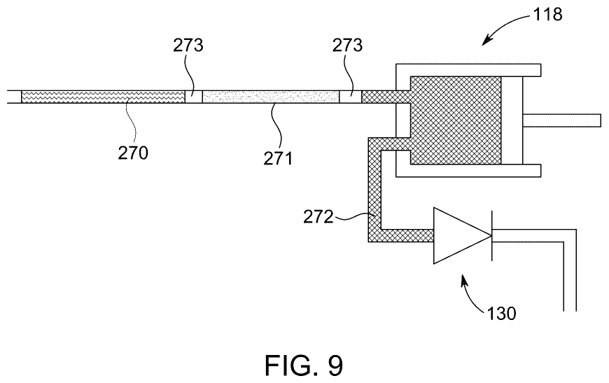

After the pump 118 is emptied, the solenoid valve 130 closes and the distribution valve 119 connects the input port 131 to the DI water port 135. The pump 118 pulls DI water into the priming line 116 between the distribution valve input port 131 and pump 118. The distribution valve 119 then connects the input port 131 to the air vent port 133 and the pump 118 pulls in a predefined amount of air. The distribution valve 119 then connects the input port 131 to the elution buffer port 137 and the pump 118 pulls a predefined amount of elution buffer into the priming line 116. Once again the distribution valve 119 moves to connect the input port 131 to the air vent port 133 and the pump 118 pulls in a predefined amount of air. Now, the distribution valve 119 connects the input port 131 to the wash buffer port 136 and the pump 118 pulls in a predefined amount of wash buffer. At this point the priming line 116 between the pump 118 and the distribution valve 119 is primed with wash buffer 270, elution buffer 271 and DI water 272, as shown in FIG. 9. The elution buffer 271 is encapsulated in the priming line 116 with air 273 to prevent any mixing between the wash buffer, DI water and elution buffer. It should be understood that FIGS. 8 and 9 are not to scale.

One skilled in the art can appreciate that a sequence of distribution valve, pump, and solenoid valve actions may ensure that the pump 118 is filled with DI water with little to no air when the DI water is initially loaded. Further, one skilled in the art can appreciate that the air space 273 between the buffers in the line can be made to be very small, but large enough to prevent mixing of the buffers. These steps will ensure accurate dispensing of buffers into the cartridge by minimizing any spring action of the air in the line or pump. Further, one skilled in the can appreciate that carrying out this sequence of events can help ensure that only DI water 272 is present in the pump. This can be advantageous because different buffers may be used depending upon which assay is being processed by the present invention. In some cases certain buffers may degrade the pump seals and leach contaminates into the buffers and fluidic lines where these contaminates may find their way into the cartridge, fluoresce during the read process, and generate noise, which could compromise sensitivity.

Once the line 116 has been primed with the buffers, the distribution valve connects the input port 131 to the manifold port 138 and the pump 118 pushes the primed fluids to the end of the fluid delivery line 115 in the manifold. At this point the fluidic system is ready to dispense the fluids in controlled volumes at the appropriate time into the cartridge for assay processing. While the depicted embodiment shows a single valve that operates to fill the priming line with various fluids, in some embodiments, multiple valves may be used to fill the priming line. Likewise, embodiments of the disclosure may be various pumps and valves that cooperate to inject the desired fluids into the cartridge, rather than using a primed line.

In another aspect, the disclosure provides a fluid circuit for isolating a target analyte of the sample and collecting a quantity of a first label that is proportional to the concentration of the target analyte in the sample.

In some embodiments, the cartridge 150 is planar and the fluid circuit or circuits of the cartridge lie in a single plane. For example, in some embodiments, the cartridge 150 is a round flat disc and the chambers, passages, and channels of the cartridge are positioned circumferentially around the cartridge. The term circumferentially, as used herein, refers to the angular or circumferential direction, as opposed to a radial or axial direction. Unless otherwise stated, the term circumferentially is not intended to mean extending about the entire circumference of the cartridge, but rather to denote the circumferential direction in the plane of rotation. In some embodiments, at least a group of chambers and channels of the fluid circuit may be sequentially connected circumferentially around a portion of the cartridge. In other embodiments, the cartridge has a flat rectilinear configuration with a single fluid circuit, or several fluid circuits arranged in one or more rows.

In some embodiments, the cartridge may include a flat base and a molded body disposed over the base, where the body includes an open path extending therethrough that defines the chambers and channels of the cartridge 150. In some embodiments, the body may be a single integral piece. Thus, for example, in some embodiments, the side walls of all of the chambers and interconnecting channels of the cartridge may be formed by a single integral piece that forms the body. Moreover, in some embodiments the body also forms the upper walls of the chambers and channels. In other embodiments, the upper walls of the cartridge are formed by a cover that is opposite the base and attached to the body. As an example, the body may be a single molded piece of cyclic olefin polymer that is 5 mm thick and the base may be a laminate of cyclic olefin polymer that is 188 microns thick. The laminate may be bonded to the body using laser welding or ultrasonic welding to provide a bond that is as strong as the materials being bonded together. In some embodiments, the base of the cartridge 150 extends over and closes the chambers and microfluidic channels of the cartridge, although it may also include ports, as described above, to receive fluids or allow venting from the cartridge.

In some embodiments, the cartridge is configured to receive a sample in a range of 50 microliters to 1 milliliter. For example, in some embodiments, the cartridge is configured to receive a sample in a range or 100 to 300 microliters. In particular, the cartridge may include a metered chamber for receiving the sample.

In some embodiments, the cartridge includes reagents stored within at least one chamber or passage in the cartridge. For example, in some embodiments, the cartridge includes reagents that are stable and dried before the cartridge is inserted into the analyzer. For example, the reagents may be lyophilized or dried onto the surface of one or more chambers of the cartridge. Or they may be in the form of lyophilized pellets placed into one or more of the chambers or the cartridge.

While the cartridge is shown and described herein in the form of a disc that spins within the analyzer, in other embodiments, the cartridge is not a disc. Moreover, some aspects of the disclosure are carried out without the use of a cartridge at all. For example, in some embodiments, aspects of the disclosure are carried out in discrete separate elements that form the different chambers.

### Processing Quality Control Camera

In some embodiments the analyzer 100 includes a processing quality control camera for monitoring the movement of substances through the cartridge 150. For example, the processing quality control camera may be mounted over the cartridge 150 so as to view the substances inside the cartridge 150. In some embodiments, the processing quality control camera is configured to output a representation of only light detected in the visible wavelength spectrum, i.e. the camera is not enabled to detect infrared or ultraviolet light. In some embodiments, the controller 140 is configured to analyze images from the processing quality control camera so as to confirm that the sample processing occurs as expected or to detect any unexpected circumstances. For example, the controller 140 may be configured to detect the presence of an undesired air bubble in the cartridge. Other example embodiments of using the processing quality control camera are described below.

In some embodiments the analyzer includes a strobe that is positioned to illuminate the field of view of the processing quality control camera. For example, the strobe may be configured to activate at a frequency that corresponds to the rotational speed of the cartridge 150, in order to monitor a specific region of the cartridge 150 as it is rotated. In particular, in some embodiments the strobe may be used when the centrifuge 101 is rotating the cartridge 150.

### Optics Quality Control Camera

In some embodiments, the analyzer 100 includes an optics quality control camera for monitoring the performance of the optical system 120. For example, the optics quality control camera may use a mirror on a slide to intercept the optical path before after the confocal stop to image the laser at the confocal stop in order to visualize that the electromagnetic radiation has the appropriate intensity, is focused in the correct location, and or has the correct intensity profile. In order to image the laser at the confocal stop the objective may be positioned so that the electromagnetic radiation source is imaged onto the surface of a window on the cartridge 150. When this is done a portion of the radiation will reflect off the window back towards the objective due to the difference in the index of refraction of the window and the media on the other side of the window. This radiation will be imaged by the optical system onto the confocal stop. The window on the cartridge may be sized of the correct thickness to simulate the thickness of the window of the detection chamber and height of the fluid layer between the window and focused spot of electromagnetic radiation. The image of the electromagnetic radiation at the confocal stop can be analyzed by the controller 140. The controller 140 may be used to analyze the images from the optics quality control camera to verify that the electromagnetic spot is of the correct size, shape, intensity and position relative to the confocal stop to ensure there are no anomalies in the optical system. The measured size, shape, intensity and position can be compared to known and accepted values for these parameters. If the measured values are outside accepted values or approaching the limits of accepted values, the controller can notify the user of the analyzer or prevent usage of the analyzer.

### Example Method

FIGS. 12 to 22 illustrate an example fluid circuit and method that utilizes various embodiments of the disclosure where the sample is blood. In other embodiments the chambers of the cartridge and methods used may be suited for other sample types. For example, analyzers, methods and cartridges of the disclosure may be suited for use with other biological fluids, such as urine, diluted stool or oral fluid. Other types of samples are also possible. Further, the samples may be neat or diluted.

### Loading and Sample Separation

As shown in FIG. 12 the fluid circuit of the cartridge 150 is initially loaded with a sample 200 in an inlet chamber 158. The inlet chamber 158 includes a sample port 153 that receives the sample 200 prior to analysis. In some embodiments, the sample 200 is received in the cartridge 150 prior to insertion in the analyzer 100, for example by a medical professional or robot that uses a syringe. In other embodiments, the inlet chamber 158 is loaded with the sample 200 after the cartridge 150 is received in the analyzer 100. As mentioned above, in some embodiments the sample port 153 can be sealed prior to insertion of the sample 200, and the seal can either be pierced or removed to enable insertion of the sample 200. In other embodiments, the sample port 153 can be a simple opening that is available to receive the sample 200 without being “opened.” In some embodiments the sample port 153 can be sealed after the sample has been input. In other embodiments the manifold 108 contains a seal to cover the port when the manifold is in contact with the cartridge. In some embodiments, the inlet chamber 158 is a metered chamber configured to receive a specific amount of sample, while in other embodiments, the inlet chamber 158 is oversized and can accommodate more sample than is used in the analysis. The inlet chamber 158 in the illustrated example of FIGS. 11 to 22 is configured to receive about 200 μl of liquid.

Once the sample 200 is loaded into the inlet chamber 158, as shown in FIG. 12, and the cartridge 150 is inserted into the analyzer 100, the cartridge 150 is coupled to the centrifuge 101, as shown in FIG. 1, so that the centrifuge 101 may spin the cartridge 150. As explained in more detail below, the geometry of the chambers and channels within the cartridge 150 are designed to influence the transfer of fluid through the cartridge 150. In order to facilitate an understanding of these geometries, the following description makes reference to cylindrical/polar directions. In particular, use of the terms “inner,” “inward”, “outer”, “outward” and similar descriptors refer to a radially inner and radially outer direction with respect to the center of rotation of the cartridge, which typically lies near the geometric center of the cartridge. The description also references a first circumferential direction and a second circumferential direction, which are related to the direction that the cartridge is configured to be spun by the centrifuge, where the cartridge is configured to be spun in the first circumferential direction. For example, an area at a first circumferential end of a chamber will pass a stationary reference position before an area at the second circumferential end of the same chamber. In the embodiment shown in FIGS. 12 to 22, the first circumferential direction is clockwise, however other embodiments of the cartridge may be configured to spin in the opposite directions, such that in these embodiments the first circumferential direction is counter-clockwise.

With the cartridge 150 loaded in the analyzer 100, the centrifuge 101 is activated to rotate the cartridge 150 in order to move the sample 200 from the inlet chamber 158 through an opening 159 into a separation area 160, as shown in FIG. 13. The rotation of cartridge 150 causes the sample 200 to move radially outward as a result of “centrifugal force,” i.e., the inertial phenomenon that causes objects to move outward when rotated. If the sample volume is greater than the amount needed for analysis, any excess may flow out of the separation area 160 through an overflow channel 165. In some embodiments, the inlet chamber 158 may be offset from the center of the cartridge 150 to facilitate the transfer of the sample to the separation area 160. In other embodiments, the inlet chamber 158 is located at the center of the cartridge 150 so that rotation of the disc-shaped cartridge 150, once loaded with the sample, will keep the sample and any other liquids received in the cartridge 150 away from the sample port 153. Further, in some embodiments, sample port 153 may be centered on the cartridge 150. In some embodiments to move the sample from the inlet chamber 158 to the separation area 160 the cartridge may for example, be spun up from 0 rpm to 1000 rpm at a rate of 2000 rpm/s and held at that speed for a couple seconds, for example 2-10 seconds. Thus the sample transfer may occur very quickly. The rotation rates and accelerations provided are exemplary and the actual rates chosen will depend on the sample being processed and may vary in rotation from 100 to 10,000 rpm with accelerations varying between 100 rpm/s and 8000 rpm/s.

In some embodiments, the separation area may include an inner separation chamber 161 and an outer separation chamber 162 configured to hold the different constituents of the sample after they are separated. In some embodiments the center of the inner separation chamber may be located at 19 mm from the center of rotation and the center of the outer separation chamber may be located at 28 mm from the center of rotation. As the centrifuge spins the cartridge 150, denser constituents of the sample are pushed radially outward into the outer separation chamber 162, while the less dense constituents move radially inward into the inner separation chamber 161. In some embodiments, the inner and outer separation chambers 161, 162 of separation area 160 are separated by a constricted neck 163 located for example at 22 mm from the center of rotation. The constricted neck 163 has a smaller cross-sectional area than either of the chambers. For example, in some embodiments the constricted neck 163 may have a cross sectional area of 3 mm² while the inner separation area 162 has an average cross-sectional area of 12 mm² and the outer separation area 162 has an average cross sectional area of 30 mm². In this example embodiment the neck 163 is sized to readily allow more dense constituents to move downward while less dense constituent move upward through the neck 163 quickly. However, as is discussed below the constricted neck 163 limits the movement of more dense constituents into the inner separation area 161 when the cartridge is rapidly decelerated.

In order to generate an accurate concentration value of the sample for further processing, it may be beneficial for the precise volume of the sample to be known. If the sample is unable to fill the separation area 160 and is unintentionally wasted, or if the separation area is sized to accept more than the sample volume, accurate concentration values might be difficult to obtain. Therefore, in some embodiments the cartridge 150 may include various features for metering a precise amount of fluid into the separation area 160.

For example, some embodiments of the cartridge 150 may include one or more features to avoid the trapping of air in the cartridge, particularly during the transfer of the sample from the inlet chamber 158 to subsequent chambers. If air is trapped in the separation area 160 as the sample is loaded therein, some of the sample may prematurely flow through the overflow channel 165 and precise metering of the sample into the separation area 160 may be unsuccessful. Accordingly, avoiding the formation of trapped air in the cartridge during loading is beneficial.

In some embodiments, the opening 159 is coupled to a first circumferential end of the inner separation chamber 161. As the sample moves outward from the inlet chamber 158 through the opening 159 and into the separation area 160, the rotation and/or acceleration of the cartridge 150 in the first circumferential direction by the centrifuge 101 can cause the sample to flow in the second circumferential direction. Accordingly, if the opening 159 is coupled to the middle of the inner separation chamber 161, additional precautions may be necessary to avoid the formation of trapped air in a corner at the first circumferential end toward the inner side of the inner separation chamber 161. However, if the opening 159 is coupled to the first circumferential end of the inner separation chamber 161, as shown in the cartridge 150 of FIGS. 12 to 22, the inclusion of an inner corner that is further in the first circumferential direction than the opening 159 is avoided. Likewise, air that might be trapped in such a corner is also avoided.

Further, in some embodiments, the opening 159 may be constricted in size and depth compared to the separation area 160. Such a constriction can slow the flow of sample into the separation area 160, allowing air to be purged from the separation area 160 while it is filling. Furthermore, the constricted size and depth may also help avoid the formation of a sheet of liquid across a cross section of the separation area 160, which could also form trapped air. For example, in one embodiment the depth of the inlet opening 159 may be 0.5 mm while the depth of the inner separation chamber 161 is 2 mm. Accordingly, the stream of sample flowing into the inner separation chamber 161 from the inlet opening 159 will not span the entire depth of the inner separation chamber 161, allowing air to flow around the stream and out of the separation area 160.

Further, in some embodiments, the cross-sectional area of the inlet opening 159 may be narrower than the cross-sectional area of the constricted neck 163 between the inner separation chamber 161 and the outer separation chamber 162. For example the inlet opening 159 may have a cross sectional area of 0.5 mm² while the constricted neck 163 has a cross sectional area of 3 mm². Accordingly, the volumetric flow rate of the sample into the separation area 160 is unlikely to overwhelm the constricted neck 163 and trap air in the outer separation chamber.

To prevent the trapping of air in the outer separation chamber 162, in some embodiments, the inner edge 164 of the outer separation chamber 162 extends at an angle projecting inward as the inner edge 164 approaches the constricted neck 163 that separates the inner separation chamber 161 from the outer separation chamber 162. Accordingly, as the outer separation chamber 162 fills with the sample due to the rotation of the cartridge, air in the outer separation chamber 162 will “float” inward to the inner edge 164 and then follow the inner edge 164 to the constricted neck 163. The air will then pass through the constricted neck 163, through the inner separation chamber 161 and out of the separation area 160.

In some embodiments, the controller 140 is configured to capture an image of the separation area 160 or a portion thereof using the processing quality control camera after the separation area 160 is filled. The controller may further be configured to analyze the image to confirm that the volume of any air bubbles within the separation area 160 is void of any air bubbles or that the volume of air in the separation area is below a predetermined threshold. For example, the controller may be configured to calculate the shape of any air bubbles within the separation area 160 and calculate the overall volume of air within the separation area 160. If the calculated volume of air is above a predetermined threshold, the controller may be configured to discontinue the analysis or disqualify the results at the end of processing. Likewise, the controller may be configured to continue the analysis if the calculated volume of air is below a predetermined threshold or is zero.

In some embodiments, the separation area 160 and surrounding channels may include one or more features for precise metering of the sample and controlled separation of components of the sample. For example, in some embodiments, the overflow channel 165 may be positioned to enable precise metering of the amount of sample 200 into separation area 160. If the amount of sample 200 received in the cartridge 150 is more than needed for the analysis, the excess will discharge through the overflow channel 165. In some embodiments, the overflow channel 165 leads to a waste chamber 166 where the excess liquid may be stored.

Due to the rotation of the cartridge 150 and the centrifugal force on the sample, the separation area 160 fills from the outer end toward the inner end. Accordingly, positioning the opening of the overflow channel 165 at a particular radial position in the inner separation chamber 161 dictates the quantity of sample that can be loaded into the separation area 160. For example, as the centrifuge 101 spins the cartridge 150 the sample will move toward the outer end of the outer separation chamber 162 and produce a fill line that moves inward as the separation area 160 fills. Once the fill line reaches radial position of the overflow channel 165, for example at a radial distance of 17 mm, any additional volume of sample that enters the separation area 160 will exit the separation area 160 through the overflow channel 165. Therefore, the quantity of the sample that will be analyzed can be precisely metered based on the radial position of the overflow channel 165.

### Separation of Sample Constituents

As shown in FIG. 14, after the sample has been loaded into the separation area 160, the centrifuge 101 may continue to spin the cartridge 150 in order to separate the sample 200 into different constituents. For example, the centrifuge 101 may spin the cartridge 150 so as to send denser constituents of the sample outward leaving less dense constituents radially inward. In some embodiments, the speed of the centrifuge 101 may be increased to separate constituents of the sample 200. For example, in one embodiment, after loading the sample the centrifuge 101 may accelerate the cartridge 150 to a speed of 1000 rpm at an acceleration of 2000 rpm/s. Upon reaching 1000 rpm the centrifuge 101 may further accelerate the cartridge 150 at 5000 rpm/s to a rate of 7000 rpm and hold at that rate for 90 seconds to separate the constituents. In another embodiment the centrifuge 101 may skip the initial transfer rotation speed and proceed directly from 0 rpm to a separation speed of 10,000 rpm at an acceleration of 2000 rpm/s. The separation step may occur at rotational speeds from 1000 rpm to 20,000 rpm depending upon the sample being analyzed, the radius of the separation chamber from the center of rotation, and the strength of the cartridge 150 to resist fracture. The duration of the separation may be carried out in a range of 10 second to 5 minutes.

In some embodiments, the sample 200 may be whole blood and the continued rotation of the cartridge 150 may separate the red blood cells 202 from the plasma 201, as depicted in FIG. 14. For example, in the separation area 160 of the illustrated embodiment, the inner separation chamber 161 may act as a plasma compartment and the outer separation chamber 162 may act as a red blood cell trap. In response to high-speed rotation of the cartridge 150, the more dense red blood cells 202 are pushed radially outward, while the less dense blood plasma 201 moves radially inward into the plasma compartment 161.

The angled inner edge 164 of the outer separation chamber 162 may aid in separating the constituents of the sample in a similar manner as it promotes removal of air from the outer separation chamber 162, as described above. As the centrifuge 101 spins the cartridge 150, the more dense constituents will move outward and the less dense constituents will move inward. Accordingly, similar to the flow path of air in the outer separation chamber 162 during the filling process, the light constituents of the sample will move inward and then follow the angled inner edge 164 of the outer separation chamber 162 until they reach the constricted neck 163 and pass through to the inner separation chamber 161.

In some embodiments, the controller 140 may be configured to capture an image of the separation area or a portion thereof using the processing quality control camera after the separation process. The controller 140 may further be configured to analyze the image to determine the fill level of denser constituents of the sample in the separation area 160. In some embodiments the controller 140 is configured to confirm that certain denser constituents of the sample have moved outward from a predetermined fill level. The controller may likewise be configured to continue the analysis in response to such a confirmation.

For example, where the sample is whole blood, the controller 140 may be configured to analyze the image to determine the fill level of red blood cells in the separation area. If the fill level of the red blood cells is outside of a predetermined radius, the controller 140 may be configured to continue the analysis. On the other hand, if the fill level of the red blood cells is inside of the predetermined radius, the controller 140 may be configured to send a control signal to the centrifuge 101 to continue spinning the cartridge in order to further separate the constituents of the blood sample. For example an image may be captured and analyzed at 90 seconds of separation time. If the level of red blood cells is inward of a threshold distance of, for example 22 mm from the center of rotation, the controller 140 may be configured to send a control signal to spin for another 30 seconds before capturing an additional image and reevaluating the level of red blood cells. In some embodiments, the duration or speed of this additional control signal may be based on the identified fill level of the red blood cells. Alternatively, the controller 140 may be configured to discontinue the analysis or disqualify the results at the end of processing. In some embodiments, the method is configured to transfer a portion of the sample that excludes the red blood cells. The inclusion of red blood cells will add hemoglobin to the plasma, which can impact the analysis. Accordingly, identifying the fill level of the red blood cells allows the quality of the blood plasma that is transferred for further analysis to be determined.

Likewise, in some embodiments the image of the separation area 160 after the separation process may be analyzed by the controller to determine the clarity of the blood plasma in the inner separation chamber. Further, the controller 140 may be configured to proceed with the analysis in response to confirming that the blood plasma meets a threshold clarity.

Further still, in some embodiments the controller 140 may be configured to analyze the image of the separated blood sample to determine a hematocrit level of the blood based on the radial distance of the red blood cell line and the time of spin. Those skilled in the art will readily appreciate that for a given chamber geometry, rotation rate and rotation time, blood of a lower hematocrit level will exhibit a separation line at a larger radius than blood with a higher hematocrit level. For a given cartridge geometry and spin parameters, different hematocrit levels can be run and evaluated to determine a calibration table that is stored in the controller 140. When a sample of unknown hematocrit is run the separation line, after a predefined spin time, can be compared to values stored in the controller to determine the hematocrit level of the sample being run. Further, the controller 140 may be configured to proceed with the analysis in response to confirming that the hematocrit level is below a predetermined threshold.

### Transfer of Supernatant

As shown in FIG. 15, a portion of the sample 200 may be removed from the separation area 160 through a siphon 167 extending from the separation area 160. The siphon 167 may be in the form of a microfluidic channel with a cross sectional area of 1 mm² that leads to a second chamber, such as mixing chamber 175. The siphon 167 may include a first section 168 extending from the separation area 160, a peak 169, and a second section 170 that extends from the peak 169 to the mixing chamber 175. The first section 168 of the siphon 167 extends from a siphon inlet 171 away from the inner separation chamber 161 toward the peak 169 in a direction that has a radially inward component. Further, the second section 170 extends from the peak 169 to a siphon outlet 172 at the mixing chamber 175. The siphon outlet 172 is further radially outward than the siphon inlet 171 of the siphon 167. For example, the siphon inlet 171 may be at a radial position of 21 mm from the center of rotation, whereas the siphon peak may be at 16 mm from the center of rotation and the siphon outlet 172 may be at a radial distance of 30 mm from the center of rotation. Other radial distances may be chosen to suit the needs of the application as long as the siphon outlet 172 is at greater radial distance than the siphon inlet 171 and the peak 169 is at a radial distance of less than both the siphon inlet 171 and siphon outlet 171. Thus, the peak 169 is the radially inner-most point of the siphon 167 and the siphon outlet 172 is radially outward compared to the siphon inlet 171. Accordingly, because the rotation of the centrifuge generally drives the sample radially outward, once a portion of the sample passes over the peak 169, the siphon 167 will drive a portion of the sample from the inner separation chamber 161 to the mixing chamber 175.

In some embodiments, the siphon may be primed, i.e., a portion of the sample may be compelled past the peak to begin the siphoning action, through capillary action. In other words, capillary force may draw the sample into the first section 168 of the siphon 167 and over the peak 169 until the siphoning action draws further fluid from the inner separation chamber 161. The cross-sectional area of the siphon 167 may be smaller, for example about 0.1 mm² to about 0.3 mm², or about 0.2 mm², to facilitate capillary action. In other embodiments, the siphon 167 may be primed through the use of pumps that draw the sample into the siphon 167 until the sample passes the peak.

Further, in some embodiments the siphon may be primed by acceleration. For example, in one embodiment after the cartridge 150 completed the separation step at 7000 rpm it is slowed down by the centrifuge 101 to 3000 rpm at a deceleration rate of 2000 rpm/s to prepare for the siphon step. While the cartridge 150 is spinning in the first circumferential direction, inertia will cause the sample to be impelled to continue moving in that direction. Accordingly, if the cartridge 150 is decelerated quickly from 3000 rpm to 0 rpm for example at 8000 rpm/s, inertia will cause the sample 200 to continue moving in the first circumferential direction and the sample will flow through the first section 168 of the siphon 167 due to its extension along the first circumferential direction and through the peak 169 which is radially outward of the fill level of the separation area 160. At this point the centrifuge 101 may reverse the direction of spin to −1000 rpm at an acceleration of 2000 rpm/s and hold that speed. Centrifugal force will cause the fluid in channel 170 to move radially outward toward the siphon outlet 172 which is radially outward of the siphon inlet 171. The separation area 160 will continue to drain until the fill level is radially outward (or “drops below”) the connection where the first section 168 of the siphon 167 opens into the inner separation chamber 161. This method of priming and siphon is significantly faster than the capillary action and or pump-based priming and siphon as the entire process can occur in several seconds. In some embodiments, the peak 169 is radially inward of the overflow channel 165, which prevents sample from flowing through the siphon 167 while the separation area 160 is being filled. Other rotational speeds and accelerations can be used as long as the acceleration is enough to force the fluid over the siphon peak 169 and the cartridge 150 continues to spin pulling fluid out of the separation area 160.

As stated above, the first section 168 of the siphon 167 extends in the first circumferential direction and radially inward. Further, in some embodiments, the shape of the first section 168 of the siphon 167 is particularly shaped to promote priming of the siphon 167. For example, in some embodiments a portion of the first section 168 at the end that is connected to the inner separation chamber 161 is substantially parallel to the first circumferential direction, e.g., within 10 degrees of parallel. As the first section 168 extends toward the peak 169 it gradually curves inward. As stated above, upon deceleration of the cartridge 150 the sample is urged in the first circumferential direction. Accordingly, with the first portion of the first section 168 substantially aligned with the first circumferential direction, the sample flows into the siphon 167 with great momentum. As a result of this momentum, the sample is able to reach and flow past the peak 169, thereby priming the siphon 167.

In some embodiments, the position of the connection between the first section 168 of the siphon 167 and the inner separation chamber 161 is selected to transfer a metered amount of sample through the siphon 167. For example, in the depicted embodiment in FIG. 13, the siphon 167 will transfer a precise amount of the sample, for example 50 microliters, based on the distance between the opening of the overflow channel 165 and the opening of the first section 168 of the siphon 167 in the radial direction. As the sample is transferred through siphon 167, the fill level in the inner separation chamber 161 will fall (i.e., move radially outward) and be replaced by air from the opening 159 of the inlet chamber 158 or overflow channel 165. Once the interface between the sample and the air reaches the first section 168 of the siphon 167, no additional amount of the sample will be pulled from the inner separation chamber 161. Accordingly, the position where the first section 168 opens into the inner separation chamber 161 may be used to define a metered amount of sample that is transferred to downstream chambers.

The position of the opening 171 of the first section 168 of the siphon 167 into the inner separation chamber 161 may also be selected to limit the transfer through the siphon 167 of only certain constituents of the sample. For example, in the embodiment where the sample is whole blood and the separation chambers 162, 161 are used to separate the red blood cells from the plasma, the opening 171 of the first section 168 may be positioned radially inward from the separated red blood cells. An unintentional inclusion of red blood cells in the sample that is transferred to the mixing chamber can result in hemoglobin contamination during the mixing process. Accordingly, it is advantageous to place the opening of the first section 168 to avoid the inclusion of red blood cells in the sample that is transferred through the siphon 167. Therefore, where the outer separation chamber 162 is a red blood cell trap that is configured to receive the red blood cells after the separation process, the opening 171 of the first section 168 may be positioned radially inward from the from the red blood cell trap and within the plasma container. Likewise, the volume of the outer separation chamber 162 may be selected based on typical red blood cell volumes, for example a hematocrit level of 52% to ensure that the volume of the red blood cell trap can accommodate the volume of red blood cells present in most whole blood samples.

In some embodiments the outer separation chamber 162 extends away from the constricted neck 163 in the first circumferential direction. Accordingly, as the cartridge 150 is decelerated and the less dense constituents of the sample are urged through the siphon 167, the more dense constituents are likewise urged toward the closed end of the outer separation chamber 162 and away from the constricted neck 163 and the siphon entrance 171. For example, in embodiments using whole blood, as the blood plasma that is above the constricted neck 163 is transferred through the siphon 167, the red blood cells are urged toward the closed end of the red blood cell trap formed by outer separation chamber 162.

As discussed a large deceleration may be used to prime the siphon. As the cartridge is decelerating the dense components in the outer separation chamber move towards the closed end and away from constricted neck 163. However, there may be a density gradient in the outer separation chamber where the fluid density is higher toward the more radially outward portions of the outer separation chamber 162. In this case there can be some backflow at the top of the outer separation chamber where the separated components at the top of the chamber move toward the constricted neck 163. If those components move far enough toward the neck 163 they may be carried up into the upper separation chamber 161 and siphoned out of the outer separation chamber 162 into the mixing chamber 175.

In some embodiments, the cartridge includes pillars 191 within the outer separation chamber 162. The pillars 191 are formed by attachment structures that extend across the outer separation chamber 162 and secure opposing sides of the cartridge together. For example, the pillars 191 may be formed by raised protrusions in the body of the cartridge that are attached to the cover of the cartridge, to provide support between the body and the cover within the outer separation chamber 162. Such support can help prevent separation between the cover and the body as the cartridge spins, particularly at high rpm while the sample components are being separated and the pressure within the outer separation chamber 162 is elevated.

### Sample Mixing

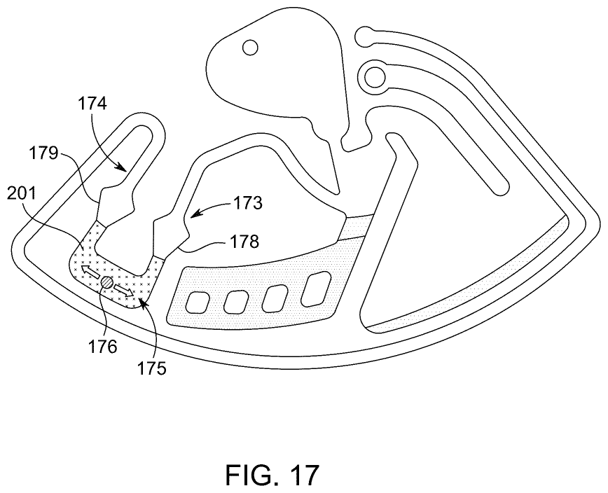

From the separation area 160, the blood plasma 201 moves to the mixing chamber 175 which may have reagents 157 therein, as shown in FIG. 16. For example, the mixing chamber 175 may include lyophilized paramagnetic capture beads, a detection label, a control analyte, and a control label. Once in the mixing chamber 175, the blood plasma is mixed with the reagents by rapid acceleration and deceleration of the cartridge 150, all while continuing to rotate in the first circumferential direction, as shown in FIG. 17.

In some embodiments, the mixing of the blood plasma with the reagents is facilitated by a mixing ball 176 disposed in the mixing chamber 175. The acceleration and deceleration of the cartridge 150 as it rotates in the first circumferential direction causes the mixing ball 176 to move back-and-forth through the mixing chamber 175 bouncing off the walls thereof. For example, in one embodiment the centrifuge 101 may move the cartridge 150 at rotational speed between 200 rpm and 500 rpm accelerating and decelerating at 1500 rpm/s. This corresponds to a mix frequency of 5 Hz. The turbulent movement of the mixing ball 176 initially rehydrates and releases the paramagnetic capture beads, detection label, control analyte, and control label into the plasma. The mixing ball 176 furthermore helps facilitate the binding kinetics of the target analyte to the paramagnetic capture beads 177 (FIG. 18) and detection label. After the mixing step, the target analyte and detection label may be attached together and to the paramagnetic capture beads that are dispersed throughout the blood plasma. In some embodiments, the rehydration of the reagents and the incubation of the target analyte occur in less than 20 minutes, for example, less than 10 minutes, or less than 5 minutes.

In some embodiments the mixing chamber 175 has geometric features that enhance the mixing ability of the mixing ball 176 by varying the direction of the mixing ball 176. For example, in some embodiments, the outer surface of the mixing chamber 175 includes a rough or textured surface to promote bouncing of the mixing ball as it rolls back and forth. Likewise, in some embodiments, the outer surface of the mixing chamber 175 may include a radially inward projection so as to cause the mixing ball to “jump” as it passes over the projection. Further, in some other embodiments the ends of the mixing chamber 175 are sloped in the radially inward direction to push the mixing ball inward at the ends of the mixing chamber and cause the mixing ball reverse directions and pass back through mixing chamber near the radially inner side of the mixing chamber. For example, both ends can have such a slope to enable a figure eight pattern of the mixing ball as the cartridge is moved rotational back and forth.

The term “mixing ball” is used herein in reference to the movement of this feature, and not with regard to any particular shape. Thus, the mixing ball 176 may be spherical in some embodiments, but have another shape in other embodiments. As examples, the mixing ball 176 may be oval, cubical, or star shaped. In some embodiments, the mixing ball is non-magnetic. The term non-magnetic, as used herein, includes those materials that are neither magnetic nor paramagnetic. Further, in some embodiments, the surface of the mixing ball includes a substance that has low reactivity. For example, in some embodiments the mixing ball 176 may include brass, glass or Teflon. Plastic, ceramic or other hard materials with a density higher than the sample may also be used for the mixing ball. In other embodiments, particularly those where paramagnetic capture beads are not used, the mixing ball 176 may include ferromagnetic materials, such as steel. Likewise, in some embodiments the mixing ball is coated with a substance that has a low reactivity.

In some embodiments, the mixing chamber 175 and surrounding channels include one or more features to retain the sample in the mixing chamber during a mixing process. For example, as illustrated in FIG. 17, in the fluid circuit 151, both the ante mixing chamber channel 173 and the post mixing chamber channel 174 extend radially inward from the mixing chamber 175. Accordingly, centrifugal force as the cartridge 150 is spun by the centrifuge 101 urges the sample outward and into the mixing chamber 175.

Likewise, to prevent movement of the sample out of the mixing chamber by capillary action, at least one of the channels 173, 174 connected directly to the mixing chamber 175 may include a capillary break 178, 179. For example, in the cartridge 150 as shown in FIG. 16, both the ante mixing chamber channel 173 and the post mixing chamber channel 174 include respective capillary breaks 178, 179. Each of the capillary breaks 178, 179 is formed by a section of the respective channel 173, 174 that expands in the direction leading away from the mixing chamber 175. The expanding cross sectional area of the capillary break 178, 179 results in a reduced capillary force as the sample moves away from the mixing chamber 175. The use of capillary breaks 178, 179 reduces the effect of capillary action and keeps the incubated fluid in the chamber after the mixing and incubation of the paramagnetic capture beads, detection labels, control analytes, and control labels. This enables time for the magnet 145 to pull the paramagnetic beads out of suspension without the incubated fluid leaving the chamber 175 as is discussed in more detail below. In the embodiment shown in FIGS. 12-22, the capillary breaks are in the form of diamonds. In other embodiments, other shapes that expand as they project away from the mixing chamber 175 are also possible.

Further, the use of two capillary breaks may help balance the forces on the sample to retain the sample in the mixing chamber 175. For example, the mixing chamber 175 may be filled to such an extent that the fill line lies on both sides of the mixing chamber 175 within the capillary breaks 178, 179. Accordingly, if the sample moves toward one side of the mixing chamber, such that the fill line in one of the channels moves radially inward toward a widened section of the respective capillary break (e.g., 178), the capillary force within that channel will be reduced. Simultaneously, the fill line in the channel on the opposing side of the mixing chamber 175 should move radially outward and into a smaller cross-sectional area of the opposing capillary break (e.g., 179) where the capillary force will be stronger. Thus, the capillary forces on the sample from both capillary breaks will urge the sample to remain within the mixing chamber. To help facilitate this balancing effect, in some embodiments the two capillary breaks 178, 179 are at the same radial position.

The capillary breaks 178, 179 may also serve as a reservoir to hold a portion of the sample during the early stages of the mixing process. In some embodiments the reagents may be stored in a stable and dry form within the cartridge 150. For example, the reagents may be lyophilized prior to the analysis method of the disclosure. In such a case, the mixing of the blood plasma and the lyophilized reagents that occurs within the mixing chamber 175 may result in the release of air that was captured during the lyophilization process. Again, due to centrifugal force caused by rotation of the cartridge, this air will move radially inward and out of the sample as the mixing process ensues. Thus, the overall volume that is occupied by the sample when it first reaches the mixing chamber is larger than later in the mixing process when the air has been released. The capillary breaks 178, 179 can act as a reservoir to hold a portion of the sample until the air has been released and allowed to escape from the sample.

In some embodiments, the controller 140 may be configured to capture an image of the mixing chamber 175 or a portion thereof using the processing quality control camera after the transfer from the separation area 160. The controller 140 may further be configured to analyze the image to determine the fill level of the mixing chamber 175. Knowledge of the precise volume of the sample that is analyzed can be useful in determining an accurate concentration of the target analyte. Accordingly, the controller 140 may be configured to proceed with the analysis in response to determining that the volume in the mixing chamber 175 exceeds a threshold value. Furthermore, the controller 140 may be configured to use the volume of the sample that is analyzed for normalizing the data resulting from the analysis.

In some embodiments, the volume of the portion of the sample that is transferred to the mixing chamber 175 is larger than the volume of the mixing chamber, such that a portion of the sample remains in the ante mixing chamber channel 173 and the post mixing chamber channel 174. Thus, the controller 140 may be configured to identify the meniscus line of the sample in both channels from the image captured by the processing quality control camera and calculate the volume based on the position of these meniscus lines.

FIG. 23 shows another embodiment of a fluid circuit 351 in accordance with the disclosure. Fluid circuit 351 includes a port 352 and channel 355 which is coupled to mixing chamber 375. Port 352 and channel 355 enable the introduction of liquid reagents 457 into the fluid circuit 351 (and associated cartridge) at time of use. This may occur for example when a sample is loaded into sample chamber 358. The rotation of a cartridge on which fluid circuit 351 is included causes the liquid reagents 457 to move radially outward as a result of “centrifugal force,” into mixing chamber 375. This may occur at the same time the sample is transferred to the separation chambers 361 and 362. The liquid reagents 457 may remain in mixing chamber 375 throughout the centrifugation process as previously described. After centrifugation is complete and the supernatant is transferred into mixing chamber 375, the supernatant may be mixed with the binding partners contained within the liquid reagents 457 in a similar manner as described above where the binding partners were contained in the lyophilized pellets.

While the illustrated embodiment of FIG. 23 shows the liquid reagent port 352 and channel 355 off to the right of the mixing chamber 375 with the reagent channel intersecting the siphon channel, in other embodiments the liquid reagent channel and port may be provided in other locations. For example, in some embodiments, the liquid reagent channel may directly connect to the mixing chamber between inlet and outlet channels of the mixing chamber with the liquid reagent port being located radially inward.

### Magnetic Movement of Sample

In some embodiments the analyzer 100 may include one or more magnets 145 configured to move the paramagnetic capture beads as described in more detail below. As illustrated in the cross-sectional portion of the analyzer 100 shown in FIG. 24, each of which may be coupled to moveable stages 147, 148. The magnets 145, 146 may be positioned above or below the cartridge in order to enable movement of the paramagnetic capture beads 177 from outside of the cartridge 150. Linear movement of the magnet 145 in the radial direction and axial directions, combined with rotation of the cartridge 150 by the positioning motor 110 of the manifold allows the magnet 145 to be positioned over any portion of the cartridge 150 without the need to move the magnet 145 in the circumferential direction. Thus, in some embodiments, the stage 148 may be enabled to move the magnets 145, 146 forward and backward along the radial direction of the cartridge 150 using the radial magnet stage 148, as well as toward and away from the cartridge 150 in the axial direction to introduce or remove the magnetic attraction of the paramagnetic capture beads 177 using the axial magnet stage 147. In other embodiments, movable stages may be operable to move in three dimensions so as to move over any portion of the cartridge 150 without the need for the cartridge 150 to be rotated. In some embodiments, the magnet may be an electromagnet, while in other embodiments, the magnet may be a permanent magnet. Further, in some embodiments the electromagnets can be activated using AC current to further facilitate manipulation of the paramagnetic beads.

Once the contents of the mixing chamber 175 are thoroughly mixed and the target analytes are attached to the dispersed paramagnetic capture beads 177 (as shown in FIG. 17), the paramagnetic capture beads 177 beads may be secured in a portion of the mixing chamber 175 by a magnet or other means. With the paramagnetic capture beads 177 secured in the mixing chamber 175, a wash buffer 270 may be pumped through the mixing chamber 175 so as to remove the blood plasma 201 therefrom, as shown in FIG. 19. As the wash buffer 270 from the delivery line 115 is pumped into the cartridge, it travels along the path 156 to the mixing chamber 175 pushing the blood plasma 201 as well as any other contaminants that are not bound to the paramagnetic beads 177 out of the mixing chamber 175 and toward the waste chamber. As the wash buffer 270 continues to flow over the paramagnetic beads 177 and the walls of the cartridge, unwanted contaminants are washed away. With repeated washing, the concentration of such contaminants can be reduced to undetectable or manageable levels.

To facilitate movement of the paramagnetic capture beads 177 through the cartridge 150, the magnets 145, 146 may be introduced. With the magnet 145 placed adjacent to the mixing chamber 175, the cartridge 150 may be rotated back-and-forth over the magnet 145 in order to gather the paramagnetic capture beads 177 into a bolus, as shown in FIG. 18. In some embodiments, the controller 140 is configured to capture an image of the bead bolus after the paramagnetic capture beads have been collected using the magnet 145. This may occur in the mixing chamber or at some other position in the circuit. Further, in some embodiments, the controller 140 is configured to measure the size of the paramagnetic bead bolus and proceed with the analysis if the size of the bead bolus is within a predetermined range. Otherwise the controller 140 may identify an error and discontinue the analysis or disqualify the results at the end processing.

In some embodiments, the magnets 145, 146 may be introduced before the introduction of the wash buffer. In such embodiments, during the purging of the blood plasma 201 from the mixing chamber 175, the bolus of paramagnetic capture beads 177 may be held in a particular location of the mixing chamber 175 to avoid dispersion of the bolus. For example, the bolus may be positioned in a corner of the mixing chamber 175 during the purging of the blood plasma.

In some embodiments, the wash buffer 270 is introduced into the cartridge 150 via the manifold 108 from the fluid delivery line 115 using the pump 118, as shown in FIG. 8. For example, in some embodiments, the pump 118 moves a portion of the contents of the pre-filled priming line 116 into the cartridge 150 via the manifold 108. Because the path 156 (FIG. 11) in the fluid circuit 151 is isolated between the inlet port 154 and the mixing chamber 175, a simple injection of the contents of the priming line 116 into the cartridge 150 will push the wash buffer 270 through the circumferential channel 182, through the radial channel 181, around the elbow 180, through the post mixing chamber channel 174 and into the mixing chamber 175. The term “isolated” as used herein, means that there are no separate branches extending from the path or openings in the path for fluid to escape. Accordingly, fluid pumped into the cartridge via the inlet port 154 will eventually arrive at the mixing chamber 175. In the illustrated embodiment, the isolated path continues from the mixing chamber 175 to the separation area 160. However, in other embodiments, the fluid circuit may include other branches that are connected to the mixing chamber. Further, aspects of the disclosure may be utilized without such an isolated path.

In some embodiments, the controller 140 may be configured to capture an image of at least a portion of the mixing chamber 175 after it is filled with wash buffer 270. Further, the controller 140 may be configured to analyze the image of the mixing chamber 175 to confirm the absence of air within the mixing chamber 175 or to confirm that the volume of any air bubbles within the mixing chamber is below a predetermined threshold. For example, the controller 140 may be configured to calculate the shape of any air bubbles within the mixing chamber 175 and calculate the overall volume of air within the mixing chamber 175. If the calculated volume of air is above a predetermined threshold, the controller may be configured to pump in more fluid or discontinue the analysis. Likewise, the controller may be configured to continue the analysis if the calculated volume of air is below a predetermined threshold or is zero.

With the paramagnetic capture beads 177 collected into a bolus in the mixing chamber 175, as shown in FIG. 19, the magnet 145 may be moved by the movable stage 148 in conjunction with rotation of the cartridge 150 to carry the bolus of paramagnetic capture beads 177 around the elbow 180 and into the radial channel 181, which may act as a further wash zone of the cartridge 150. In some embodiments, the controller 140 may be configured to capture an image of at least a portion of the radial channel 181 after the bead bolus of paramagnetic capture beads 171 has been transferred to the radial channel 181 to verify that the transfer has taken place. Further, in some embodiments, the controller 140 is configured to measure the size of the paramagnetic bead bolus in the radial channel 181 and proceed with the analysis if the size of the bead bolus in the radial channel 181 is within a predetermined range. Otherwise the controller 140 may identify an error and discontinue the analysis or disqualify the results at the end of processing.

Once the paramagnetic capture beads 177 are disposed in the radial channel 181, the movable stage 148 may be moved back and forth to effectively wash the paramagnetic capture beads 177, removing appreciable levels of contaminants from the sample except the target analyte, detection label and any controls used in the system, as schematically shown in FIG. 20. In some embodiments, the spent wash buffer may be repeatedly swept out of the radial channel 181 and a new volume of wash buffer 270 added to the radial channel 181 before repeating the wash step. The washing step may be performed several times, for example three or more times.

In some embodiments, a second magnet 146 may be introduced during the washing step to disperse and recondense the paramagnetic capture beads 177 during a series of steps of a washing operation. In particular, the magnet 145 and the second magnet 146 may be disposed on opposite sides of the cartridge 150 in order to disperse and recondense the paramagnetic capture beads 177 as they move along the radial channel 181. Spreading out the paramagnetic capture beads 177 allows them to be more efficiently washed by the wash buffer than if the beads held together in a bolus. Accordingly, the time and number of cycles needed for the washing step may be reduced compared to conventional washing methods.

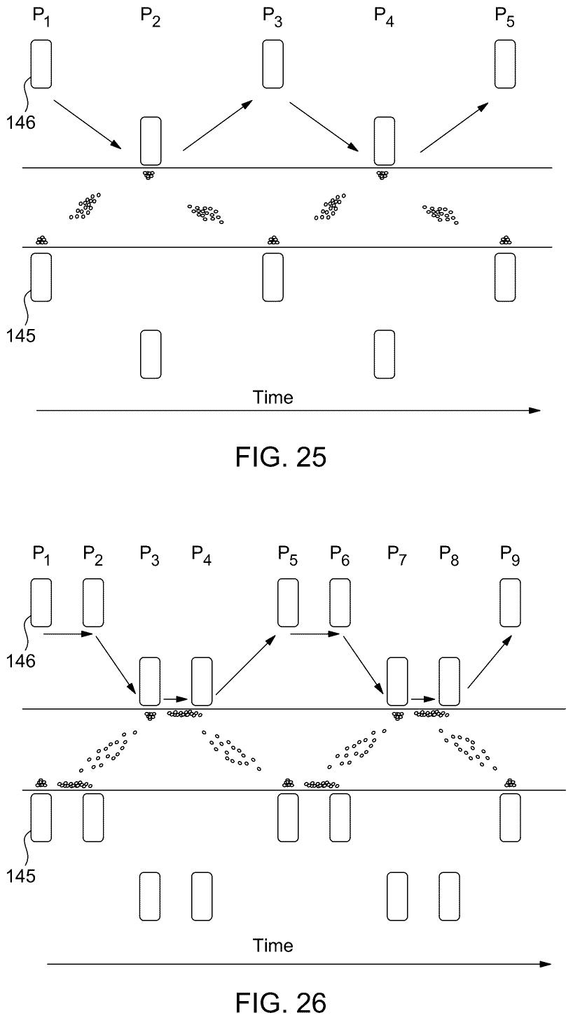

FIGS. 25 and 26 illustrate two example embodiments of a washing operation according the invention. FIG. 25 illustrates a washing operation in which two magnets 145, 146 are moved with respect to the radial channel 181 in a saw tooth pattern. In particular, FIG. 25 illustrates five discrete locations P1-P5 that the first magnet 145 and second magnet 146 occupy during the saw tooth washing operation. In position P1, the second magnet 146 is remote from the cartridge 150 while the first magnet 145 is adjacent to the cartridge 150, which causes the paramagnetic capture beads to form a bolus adjacent to the first magnet 145. The magnets 145, 146 are then moved in the axial direction so that second magnet 146 draws near cartridge 150 while first magnet 145 moves away from cartridge 150. In concert with this movement, the movable stage 148 may also be moved so that the magnets 145, 146 are also repositioned laterally along the radial channel 181. As the first magnet 145 moves away from the paramagnetic capture beads 177, the bolus is dispersed into the wash solution so that needless constituents of the blood plasma may be separated and washed from the paramagnetic capture beads 177. The dispersion of the paramagnetic capture beads 177 is illustrated in FIG. 25 between positions P1 and P2. As the second magnet 146 approaches the radial channel 181, the paramagnetic capture beads 177 are drawn out of suspension and again into a tight bolus. The dispersion and recondensing steps can then be repeated in the opposite direction as the magnets 145, 146 move from position P2 to position P3. Likewise, this process can be continued in a sawtooth pattern for several additional steps.

FIG. 26 illustrates another embodiment of a washing operation in which the two magnets 145, 146 are moved with respect to the radial channel 181 in a square wave or trapezoidal pattern. In particular, FIG. 26 illustrates nine discrete locations P1-P9 that the first magnet 145 and second magnet 146 occupy during the saw tooth washing operation. Again, in position P1 the second magnet 146 is remote from the cartridge 150 while the first magnet 145 is adjacent to the cartridge 150, which causes the paramagnetic capture beads to form a bolus adjacent to the second magnet 146. The movable stage 148 is then moved such that the magnets 145, 146 move with respect to the radial channel 181. Advantageously, the stage 148 may be moved at a sufficient velocity to spread the paramagnetic capture beads 177 along the surface of the radial channel, thereby dispersing the paramagnetic capture beads along the surface of the radial channel in the wash buffer. The magnets 145, 146 are then moved to position P3 such that the second magnet 146 draws near cartridge 150 while first magnet 145 moves away from the cartridge 150. Again, as the first magnet 145 moves away from the paramagnetic capture beads 177, the bolus is dispersed into the wash solution so that needless constituents of the blood plasma may be separated and washed from the paramagnetic capture beads 177. Likewise, as the second magnet 146 approaches the cartridge 150, as shown at position P3, the paramagnetic capture beads 177 are drawn out of suspension and against the wash chamber wall.

While the embodiments of wash operations shown in FIGS. 25 and 26 include recondensing the paramagnetic capture beads into a tight bolus, in other embodiments, the paramagnetic capture beads may be directed through the channels without strictly being coalesced into a bolus during the operation. For example, during the steps of the operation the beads may remain relatively dispersed in the wash fluid but moved back and forth and along the length of the radial channel by the magnets.

As stated above, in some embodiments, the magnet 145 and second magnet 146 are positioned on opposite sides of the cartridge 150, for example above and below the cartridge 150. In other embodiments, the magnets 145, 146 are disposed on the same side of the cartridge 150 but on opposite sides of the radial channel with respect to the circumferential direction. Further, in some embodiments, the magnets 145, 146 spread the paramagnetic capture beads 177 along the length of the radial channel 181. Moreover, in some embodiments, the distance between the first magnet 145 and the second magnet 146 is varied using the Z-stage 147 during the washing step. This relative movement of the magnets 145, 146 may promote the disruption of the bolus of paramagnetic capture beads 177, enhancing the washing operation.

After the washing operation, the paramagnetic capture beads 177 may be gathered again with the first magnet 145 and moved to the circumferential channel 182. The pump 118 may then be activated to push the fluid from priming line 116 further along the path 156 extending from the inlet port 154 to the mixing chamber 175. Specifically, the pump 118 operates until the first bead of air 273 is pushed past the bolus of paramagnetic capture beads 177 such that the paramagnetic capture beads 177 are immersed in the elution buffer 271, as shown in FIG. 21. While holding the paramagnetic capture beads 177 using one or more magnets 145, 146, the cartridge 150 may be rotated back-and-forth to pass the paramagnetic capture beads 177 through the circumferential channel 182 and elution buffer 271, which removes the bonds between the paramagnetic capture beads 177 and the target analyte and between the label and target analyte. This leaves a pure fluorochrome conjugate suspension in the elution buffer 271 within the circumferential channel 182, as shown in FIG. 22.

To enhance elution of the target analyte and labels, a magnetic elution operation may be used that is similar to the wash operations explained above. For example, the magnets 145, 146 may move with respect to the circumferential channel 182 in a particular pattern, such as those shown in FIGS. 25 and 26, while the cartridge is rotated with respect to the magnets. Controlling the paramagnetic beads in a controlled manner similar to that of the washing operation enhances the magnetic elution operation.

While the described embodiment uses the radial channel 181 as a washing zone and the circumferential channel 182 as an elution zone, in other embodiments, the areas where washing and elution take place may have other configurations. Further, in some embodiments, washing and elution may occur in portions of the same channel. For example, in some embodiments, washing may continue into an area of the circumferential channel that is close to the radial channel, while elution occurs in a portion of the circumferential channel that is closer to the inlet port 154. It may be advantageous, however, for the method to maintain distinct washing zone and elution zones along the path 156 from the inlet port to the mixing chamber 175, where the elution zone is closer to the inlet port 154 than the washing zone. With fluid flowing in a single direction along the path 156 through the fluid circuit 151, having the elution zone closer to the inlet port can help ensure that elution takes place in a location where the spent wash buffer has not travelled.

After the elution process has been carried out, the paramagnetic capture beads 177 may be moved outside of the circumferential channel 182, or to one end of the circumferential channel 182, as shown in FIG. 22, so as to avoid interfering with the optical system 120. The optical system 120 of the analyzer 100 may then be activated to analyze the solution in the circumferential channel so as to determine the presence or concentration of target analyte in the volume of fluid in the circumferential channel, as explained above. Accordingly, at least a portion of the circumferential channel 182 may serve as both an elution zone where the elution buffer removes the labels from the paramagnetic beads, as well as a detection zone.

FIG. 27 from left to right shows the signal from the elution buffer where elution has not occurred. In that region the signal is generally below 30 photons in each signal bin. Near the middle of the figure, a zone where labels have been eluted is clearly visible as a series bins with signals above 30 photons. To the right of the elution zone another region is visible where no labels were eluted and the signal is also generally under 30 photons per bin. To the right of that zone is the region where the bead bolus was dragged after the elution process. Since the bead substrates fluoresce and strongly scatter light, a very strong signal well above 150 photons is observed in this region. Finally, to the right of the bolus region is another region of clean elution buffer where no elution has occurred.

The entire purification process described briefly herein is designed to create a suspension containing only the isolated target analyte and the labels that were once bound to that target analyte. The paramagnetic capture beads which were used to capture the target analyte are a source of noise for the read process. After the elution sequence in which the target analyte bonds are cleaved, the dissociated paramagnetic capture beads may be pulled to a preferred location in the elution chamber as just described. The read process shown in FIG. 27 may cover multiple regions in the elution channel including pristine elution buffer zones, the elution zone and the bead bolus zone. These individual sections may be analyzed to identify and enumerate the single molecules from fluorescent labels that were carried to the elution zone via binding to the target analyte.

While the fluid circuit shown in FIGS. 10-22 includes various different structures for processing a sample using the system described herein, methods described herein may be carried out using other fluid circuits. For example, in some embodiments, a fluid circuit may be formed without any separation chambers or transfer structures. For instance, the fluid circuit may include a more direct route from the sample port to a mixing chamber. Further, in some embodiments, the fluid circuit may be configured without a separate waste chamber. For example, the flow path of the fluids delivered to the cartridge may be from the fluid inlet port toward the sample port with a sample chamber also acting as a waste chamber.

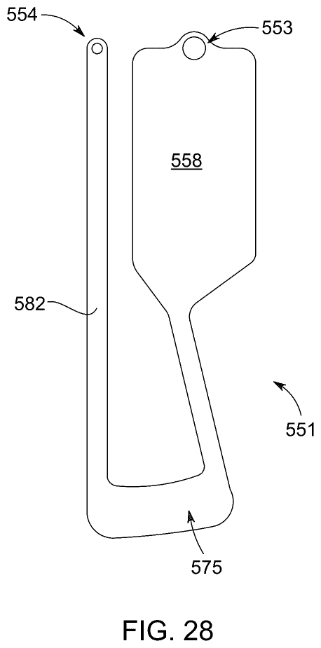

For example, FIG. 28 shows another embodiment of a fluid circuit 551 in accordance with the disclosure where an initial centrifugation step may be omitted. In contrast to circuit 151 described above, separation chambers 161 and 162 have been removed. In embodiments of using circuit 551, the sample is injected through sample port 553 into sample chamber 558. When the cartridge is rotated as previous described, the sample moves into the mixing chamber 575 due to centrifugal force without the need of priming steps. In this embodiment the sample volume input may be controlled such that an overflow channel and overflow chamber may be omitted. The same process of mixing, washing, elution and read as previously described with respect to circuit 151 may be carried out using circuit 551. Buffers are input into inlet port 554, in a similar manner as previously described with respect to circuit 151. As wash buffer is injected, the sample is pushed out of mixing chamber 575 and into sample chamber 558, which also serves as a waste chamber. At later steps the elution buffer is also input pushing the wash buffer into chambers 575 and 558. In some embodiments, different portions of channel 582 may be used for wash, elution and read. As described above with respect to circuit 151, the analyte generally moves toward inlet port 554 and the buffers and waste move towards sample port 553. In this manner, the analyte is generally exposed to a clean unsullied portion of the cartridge and clean buffers. In the embodiment of circuit 551, the read occurs in a radial direction along channel 582. However, in other embodiments such a channel may have an elbow region where the channel changes direction and ultimately bends underneath the mixing chamber in a circumferential direction and eventually back up towards the center of rotation.

Accordingly, circuit 551 shows the flexibility of the concepts described in the disclosure for use with different sample types and how different configurations may use various different aspects of the disclosure.

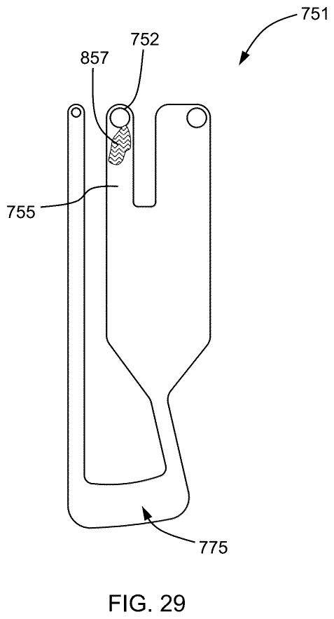

FIG. 29 illustrates another embodiment of a fluid circuit 751 in accordance with the disclosure where the initial centrifugation step may be omitted. Similar to fluid circuit 351, shown in FIG. 23, fluid circuit 751 enables liquid reagents 857 to be used. Fluidic circuit 751 includes a port 752 and channel 755 enabling liquid reagents 857 to be input into the circuit 751 in addition to a sample. The channel 755 keeps the liquid reagents 857 from mixing with the sample until the disc on which the fluid circuit 751 is included starts spinning. In various embodiments, the chamber sizes may be adjusted to accommodate different ratios of liquid reagents and sample. As previously described, once the disc is rotated, centrifugal force moves the sample and liquid reagents 857 radially outward and into mixing chamber 775. The same process of mixing, washing, elution and read as previously described with respect to circuit 151 may be carried out using circuit 751.

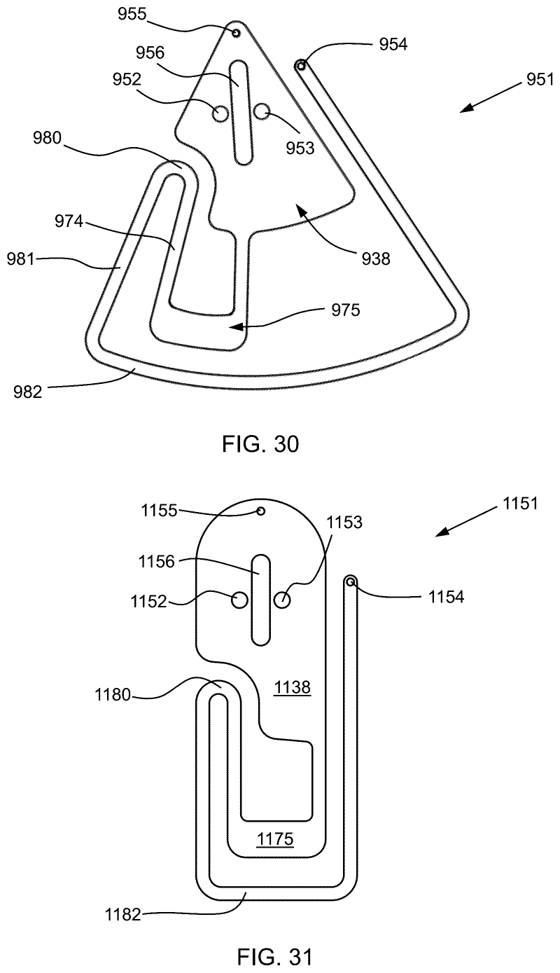

FIG. 30 illustrates another embodiment of a fluid circuit 951 in accordance with the disclosure where the centrifugal sample separation is omitted and liquid reagents are introduced into the fluid circuit 951 through a reagent port 952. The reagent port 952 and a sample port 953 are both provided in the sample chamber 938, but they are separated from one another by a divider 956. The divider 956 keeps the liquid reagents from mixing with the sample until the cartridge forming the fluid circuit 951 starts rotating. In various embodiments, the position of the divider 956 may be adjusted to accommodate different ratios of liquid reagents and sample. Alternatively, in some embodiments, the fluid circuit may include reagent and sample ports without a divider. Further, in some embodiments, the sample chamber may include a single port adapted to receive both the sample and reagent.

As previously described, once the cartridge is rotated, centrifugal force moves the sample and liquid reagents radially outward, driving these components into a mixing chamber 975. The same process of mixing, washing, elution and read as previously described with respect to circuit 151 may be carried out using circuit 951.

Similar to fluid circuit 151, the fluid circuit 951 includes a series of channels leading from the mixing chamber 975 along an isolated path to an inlet port. From the mixing chamber 975, a post-mixing chamber channel 974 extends radially inward so that fluids are driven into the mixing chamber 975 as the cartridge is rotated. The path continues along the post-mixing chamber channel 974 to an elbow 980 where it reverses direction along a radial channel 981 past the mixing chamber 975. The path then curves around the mixing chamber 975 along a working channel 982. On the opposite side of the mixing chamber 975, the path returns radially inward to the inlet port 954. Each of these channels may be used for washing and/or elution as the target analytes are moved from mixing chamber 975 toward the inlet port 954 through fresh volumes of wash buffer and/or elution buffer. The sample chamber 938 of circuit 951 also includes a vent 955 that allows the sample chamber 938 to also function as a waste chamber for spent wash buffer as fluid continues entering the fluid circuit 951 through the inlet port 954. The vent 955 allows fluid to fill the sample chamber 938 while avoiding the fluid flowing into the manifold via the reagent port 952 or sample port 953.

Each of the channels between the mixing chamber 975 and the inlet port 954 may also be used as a read chamber. The working channel 982 is particularly well suited for serving as a read chamber on a circular cartridge. The working channel 982 extends circumferentially about the cartridge at a constant radius from the rotational center. As a result, directing electromagnetic radiation along a portion of the working channel 982 may be enabled through simple rotation of the cartridge while the source is activated. Alternatively, in some embodiments, the cartridge may be a rectilinear cartridge that is configured moved along an axis of the cartridge during processing and reading. In such embodiments, the working channel may be straight, rather than curved along a circumference.

For example, FIG. 31 shows another embodiment of a fluid circuit 1151 that is adapted for a rectilinear cartridge. Similar to fluid circuit 951, the fluid circuit 1151 includes a sample chamber 1138 with a reagent port 1152 and a sample port 1153 that are separated by a divider 1156. From the sample chamber 1138, the fluid circuit 1151 extends along an isolated path through a mixing chamber 1175 toward an inlet port 1154. The sample chamber 1138 also includes a vent 1155 allowing fluids, which are pumped into the fluid circuit 1151 through the inlet port 1154, to collect in the sample chamber 1138 after flowing through the circuit.

From the mixing chamber 1175, the fluid circuit 1151 extends around an elbow 1180 to a working channel 1182 that again may function as a wash, elution, and/or read chamber. In contrast to working channel 982 of fluid circuit 951, working channel 1182 has a straight configuration. Accordingly, a sliding lateral movement of the cartridge that forms the fluid circuit 1151 can be used to introduce electromagnetic radiation along the entire length of the working channel 1182.

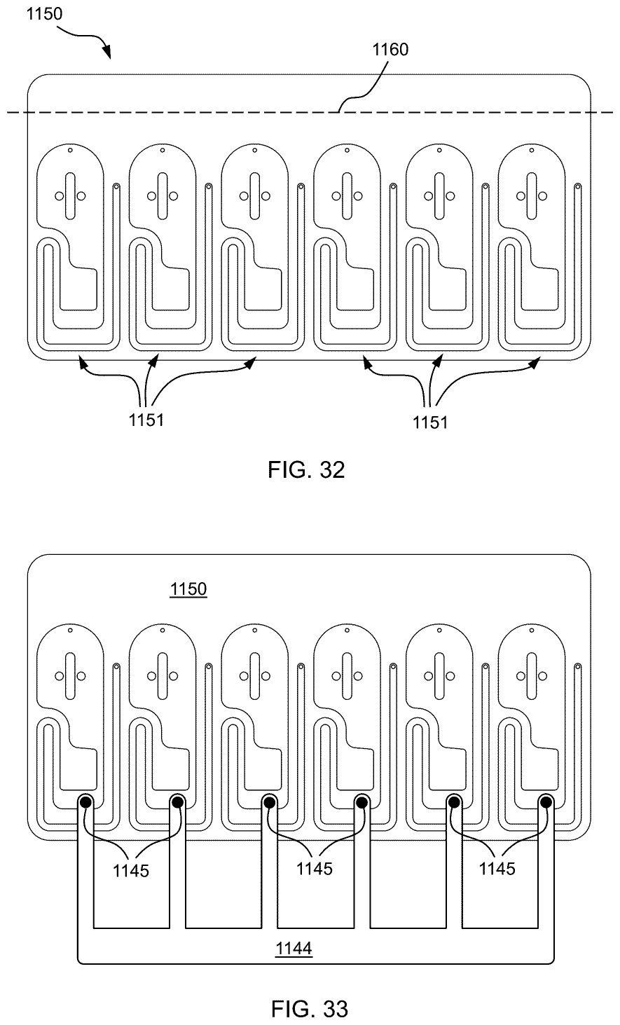

In another aspect, the disclosure provides a cartridge that includes a plurality of fluid circuits according to the disclosure. For example, FIG. 10 shows a cartridge 150 that includes three fluid circuits 151 that have the configuration shown and discussed with respect to FIGS. 11-22. Cartridge 150 allows for three samples to be processed on a single cartridge, such that three samples may be loaded in a single operation. FIG. 32 shows another embodiment of a cartridge 1150 that includes multiple fluid circuits. Specifically, the cartridge 1150 shown in FIG. 32 is formed as a rectilinear cartridge and includes six fluid circuits having the form of fluid circuit 1151 shown in FIG. 31.

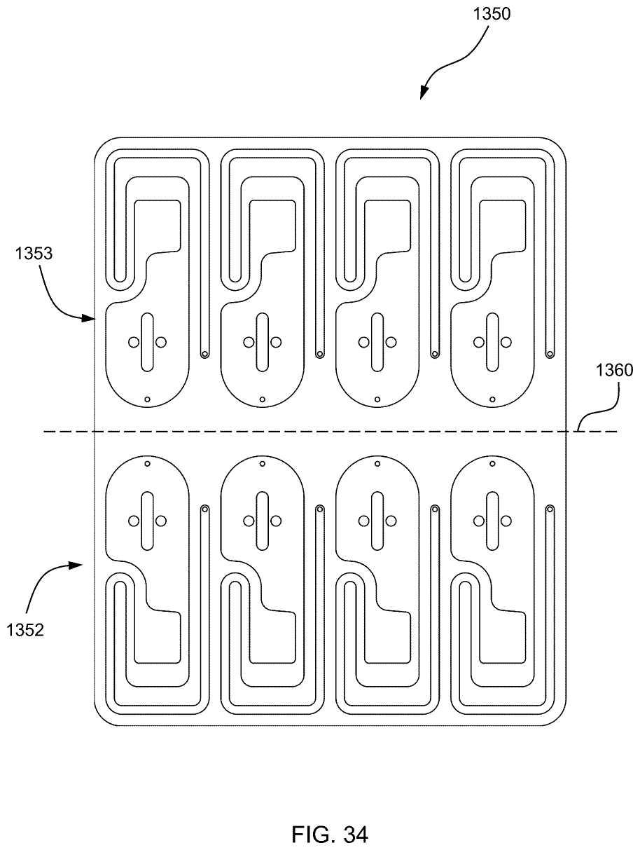

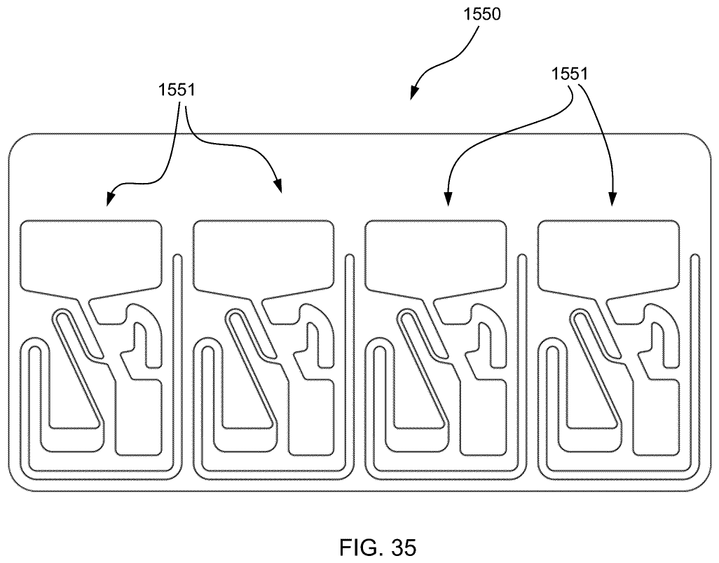

The fluid circuits 1151 of cartridge 1150 each have the same configuration and are arranged in an evenly spaced row. To move the sample from the sample chamber to the mixing chamber the cartridge is rotated so that centrifugal force drives the fluid toward the mixing chamber, as with the other cartridges described above. However, rather than rotating the cartridge in the plane of the fluid circuit, the cartridge is rotated about an axis 1160 that extends parallel to the plane of the circuit. Because each of the fluid circuits 1151 are spaced at the same distance from the axis 1160, the centrifugal force on each sample is the same. Moreover, because the fluid circuits 1151 are aligned along the row, the samples may be processed simultaneously. For mixing the sample and reagents within the fluidic circuits 1151 of cartridge 1150, the cartridge 1150 is translated back and forth along the axis 1160. Further, as shown in FIG. 33, a carrier 1144 that supports six evenly spaced magnets 1145 may be moved with respect to the cartridge 1150 and simultaneously transport all six magnets 1145 along the path of the fluid circuit in the same manner. In this way, paramagnetic beads in each fluid circuit may be drawn along the path of the fluid circuit at the same time. A second may be carrier may be used on the opposing side of the cartridge for washing or elution as explained above.

Embodiments of a rectilinear cartridge may include a row of a greater or lesser number of fluid circuits than the six circuits shown in cartridge 1150. Moreover, in some embodiments a rectilinear cartridge may include multiple rows. For example, FIG. 1350 includes a first row 1352 of fluid circuits on one side of the cartridge and a second row 1353 of fluid circuits on the opposing side of the cartridge. The fluid circuits all have the same configuration and are formed in the same plane. To equalize the centrifugal force on the sample in each fluid circuit, the cartridge may be rotated about a center axis 1360 during the initial phase of moving the fluids into the mixing chamber.

While the aforementioned examples of cartridges with multiple fluid circuits show a complex circuit in a rotational cartridge and a simple fluid circuit in a rectilinear cartridge, both cartridge types may be used with various configurations of fluid circuits. For example, fluid circuit 1151 of FIG. 30 has a wedge shape, such that several instances of fluid circuit 1151 may fit on a single rotational cartridge. Likewise, FIG. 35 shows a rectilinear cartridge 1550 that includes four similar fluid circuits 1551 that are configured for separating constituents of a sample. The fluid circuit 1551 includes a separation area and overflow channel similar to fluid circuit 151 of FIGS. 11-22. A siphon that is activated by capillary action draws fluid from the separation area to the mixing chamber, where the sample and reagents are mixed before washing, eluting and reading, as explained above.

In some embodiments, a fluid processing cartridge with multiple fluid circuits includes a group of fluid circuits where each fluid circuit has a working channel that extends along a common linear or circular path. Such a configuration allows a single read operation to be used to identify a target analyte in the working channel of each fluid circuit. For example, where the working channels of multiple fluid circuits extend along a single circular path of a rotational cartridge, such as in cartridge 150, the cartridge can simply be rotated to take readings along each working channel. Likewise, where the working channels of multiple fluid circuits extend along a straight line across a rectilinear cartridge, such as cartridge 1150, the cartridge can be moved laterally to take readings along each working channel.

While each of the illustrated fluid circuits are configured so that binding of the target analyte, label, and paramagnetic beads is facilitated together in the mixing chamber in a single step, in other embodiments this binding may occur in more than one step. For example, in some embodiments, the fluid circuit may include a pre-mixing chamber where the target analyte is bound to the paramagnetic beads. The paramagnetic beads may then be moved to the mixing chamber where the label is bound to the target analyte.

In another aspect of the disclosure, the optical system 120 of the analyzer 100 includes a second electromagnetic radiation source 128 and a second detector 129 for a multiplexing operation. In some embodiments, the analyzer second electromagnetic radiation source 128 and second detector 129 may be used for determining the presence of a second target analyte in the sample. In other embodiments, the second electromagnetic radiation source 128 and the second detector 129 may be used to measure a concentration of a control analyte in the cartridge 150. For example, the cartridge 150 may include a precise and known quantity of the control analyte. Accordingly, the measured concentration of the control analyte may be used as a comparator for the target analyte. This measured concentration can then be used to adapt the detected concentration of the target analyte.

For example, if the measured concentration of the control analyte is only 95% of the actual known concentration of the control analyte, the controller 140 can use this percentage difference to adapt the detected concentration of the target analyte. For example, the controller 140 may determine that the analyzer 100 is also only detecting 95% of the target analyte in the sample, and adjust the calculated concentration accordingly.

In some embodiments, the electromagnetic radiation from the first electromagnetic radiation source 121 and the second electromagnetic radiation source 128 are directed to the cartridge using the same objective. Indeed, in some embodiments, the electromagnetic radiation from the two sources is directed to the same interrogation space. In some embodiments, the first electromagnetic radiation source 121 and the second electromagnetic radiation source 128 emit electromagnetic radiation of different wavelengths, for example, different colors.

The disclosure provides systems and methods for highly sensitive detection and quantitation of one or more target analytes, such as markers for biological states.

### Singleplex and Multiplex Assays

In one aspect, the disclosure provides systems and methods that can perform a “singleplex” assay of a sample to detect and analyze a single type of target analyte in the sample. In other aspects, the disclosure provides systems and methods that can perform a “multiplex” assay of a sample to detect and analyze multiple (e.g., two, three or more) different types of target analytes in the sample. Using the multiplexed systems and methods described herein may provide for more rapid detection and analysis of multiple target analytes, using reduced sample volume, and reduced reagent volume than may be required to perform a similar analysis of those target analytes via singleplex assays. Further, the multiplexed systems and methods described herein can allow analysis of a sample including a target analyte to be compared to a control assay of a known concentration.

To detect and analyze multiple, different types of target analytes in a sample, the multiplexed analyzer system can distinguish one type of target analyte from the others. This can be achieved, in part, by labeling the different target analytes with different labels, which have excitation wavelength bands and/or emission wavelength bands that differ from one another. In some implementations, the different labels have excitation wavelength bands and/or emission wavelength bands with relatively little overlap or no overlap. In other implementations, there may be some overlap among the excitation wavelength bands and/or the emission wavelength bands of the labels. Multiplexing can also be achieved by implementing more than one fluidic circuit on the same cartridge with each fluidic circuit spatially distinct and carrying reagents for different target analytes. With different fluidic circuits it is not necessary for the different target labels to have different excitation and emission wavelengths. The additional circuits may collect sample from the same sample chamber or from different sample chambers.

### Electromagnetic Radiation Power and Bin Size

In the optical system, the electromagnetic radiation source 121 may be set so that the wavelength of the electromagnetic radiation is sufficient to excite a fluorescent label attached to the target analyte. In some embodiments, the electromagnetic radiation source 121 is a laser that emits light in the visible spectrum. In some embodiments, the laser is a continuous wave laser with a wavelength of 639 nm, 532 nm, 488 nm, 422 nm, or 405 nm. Any continuous wave laser with a wavelength suitable for exciting a fluorescent moiety as used in the methods and compositions of the disclosure can be used without departing from the scope of the disclosure. The power setting for the laser is generally between 1 mW and 100 mW. However, those skilled in the art will appreciate the laser power can be any setting to achieve the optimal signal to noise ratio of the measurement. To do so the laser power should be set to achieve as many excitation emission cycles as possible during the dwell time of the label in the interrogation space. The detector bin time should also be set accordingly. A bin time that is longer than the time it takes to photo bleach the label and or longer than the dwell time of the label in the interrogation space will simply enable the collection of excess noise. A laser power setting that is too low or too high or a bin time setting that is to long will not yield the highest possible signal to noise ratio.

As the interrogation space in the analyzer 100 passes over the labeled target analyte, photons emitted by the fluorescent particles are registered by the detector 122 with a time delay indicative of the time for the interrogation space to pass over the labeled particle. The photon intensity is recorded by the detector 122 and the sampling time is divided into bins, wherein the bins are uniform, arbitrary time segments with freely selectable time channel widths. The number of signals contained in each bin is evaluated. One or more of several statistical analytical methods are used to determine when a label or particle is present or when a section of bins contains an artifact. Sections of bins containing artifacts are discarded while single bins or sections of bins containing a label are counted. The number of labels counted is indicative of the number of target analytes present in the sample.

### Interrogation Volume

An interrogation volume can be thought of as an effective volume of sample in which a target analyte of interest can be detected when present. Although there are various ways to calculate the interrogation volume of the sample, the simplest method for determining the effective volume (V) of the interrogation volume is to calculate the effective cross section of the detection volume. Because the detection volume is typically swept through the sample by translating the detection volume through the stationary sample, the volume is typically the result of the cross sectional area of the detection volume being swept through some distance during the time of measurement. As previously discussed the lateral extent of the cross sectional area of interrogation volume (perpendicular to the direction of motion of the laser relative to the sample and perpendicular to the direction of propagation of the laser light) is limited by the numerical aperture at which the laser source is imaged in the sample space. The longitudinal size of the interrogation volume (along the direction of propagation of the laser) is determined by the size of the confocal stop chosen. If the sample concentration (C) is known and the number of molecules detected (N) during a period of time is known, then the sample volume consists of the number of molecules detected divided by the concentration of the sample, or V=N/C (where the sample concentration has units of molecules per unit volume).

For example, in some embodiments of the system described herein, all photons detected are counted and added up in 100 microsecond segments (photon counting bins). If a molecule of interest is present in the 100 microsecond segment, the count of photons detected is typically significantly higher than background. Therefore, the distance the detection volume has moved with respect to the sample is the appropriate distance to use to calculate the volume sampled in a single segment, i.e., the interrogation volume. In this example, if the sample is analyzed for 60 seconds, then effectively 600,000 segments are scanned. If the effective volume is divided by the number of segments, the resulting volume is in essence the volume of a single segment, i.e., the interrogation volume. Mathematically, the volume of the single segment, i.e., the interrogation volume (Vs), equals the number of molecules detected (N) divided by the concentration of the sample multiplied by the number of segment bins (C·n—where n represents the number of segment bins during the time the N number of molecules were counted). For exemplary purposes only, consider that a known standard of one femtomolar concentration is run through 600,000 segments, and 20 molecules of the standard are detected. Accordingly, the interrogation volume, Vs, equals N/(C-n) or 20/(602.214.6E5), or 55.351 μm3. Thus, in this example, the interrogation space volume, which is the effective volume for one sample corresponding to one photon counting bin, is 55.351 μm3.

### Detectors

In some embodiments, light emitted by a fluorescent label after exposure to electromagnetic radiation is detected. The emitted light can be, e.g., ultra-violet, visible or infrared. For example, the first detector 122 may capture the amplitude and duration of photon bursts from a fluorescent moiety, and convert the amplitude and duration of the photon bursts to electrical signals. Detection devices such as CCD cameras, video input module cameras, and Streak cameras can be used to produce images with contiguous signals. Other embodiments use devices such as a bolometer, a photodiode, a photodiode array, avalanche photodiodes, and photomultipliers which produce sequential signals. Any combination of the aforementioned detectors can be used.

### Molecules for Concentration Analysis

The instruments, kits and methods of the disclosure can be used for the sensitive detection and determination of concentration of a number of different types of target analytes, such as markers of biological states.

Examples of molecules or “analytes” that can be detected using the analyzer and related methods of the disclosure include: biopolymers such as proteins, nucleic acids, carbohydrates, and small molecules, both organic and inorganic. In particular, the instruments, kits, and methods described herein are useful in the detection of target analytes of proteins and small molecules in biological samples, and the determination of concentration of such molecules in the sample.

The molecules detected by the present systems and methods can be free or can be part of a complex, e.g., an antibody-antigen complex, or more generally a protein-protein complex, e.g., complexes of troponin or complexes of prostate specific antigen (PSA).

In some embodiments, the disclosure provides compositions and methods for the sensitive detection of biological markers, and for the use of such markers in diagnosis, prognosis, and/or determination of methods of treatment.

Markers can be, for example, any composition and/or molecule or a complex of compositions and/or molecules that is associated with a biological state of an organism (e.g., a condition such as a disease or a non-disease state). A marker can be, for example, a small molecule, a polypeptide, a nucleic acid, such as DNA and RNA, a lipid, such as a phospholipid or a micelle, a cellular component such as a mitochondrion or chloroplast, etc. Markers contemplated by the disclosure can be previously known or unknown. For example, in some embodiments, the methods herein can identify novel polypeptides that can be used as markers for a biological state of interest or condition of interest, while in other embodiments, known polypeptides are identified as markers for a biological state of interest or condition. Using the systems of the disclosure it is possible that one can observe those markers, e.g., polypeptides with high potential use in determining the biological state of an organism, but that are only present at low concentrations, such as those “leaked” from diseased tissue. Other high potentially useful markers or polypeptides can be those that are related to the disease, for instance, those that are generated in the tumor-host environment. Any suitable marker that provides information regarding a biological state can be used in the methods and compositions of the disclosure. A “marker,” as that term is used herein, encompasses any molecule that can be detected in a sample from an organism and whose detection or quantitation provides information about the biological state of the organism.

Biological states include but are not limited to phenotypic states; conditions affecting an organism; states of development; age; health; pathology; disease detection, process, or staging; infection; toxicity; or response to chemical, environmental, or drug factors (such as drug response phenotyping, drug toxicity phenotyping, or drug effectiveness phenotyping).

The term “organism” as used herein refers to any living being comprised of a least one cell. An organism can be as simple as a one cell organism or as complex as a mammal. An organism of the disclosure is preferably a mammal. Such mammal can be, for example, a human or an animal such as a primate (e.g., a monkey, chimpanzee, etc.), a domesticated animal (e.g., a dog, cat, horse, etc.), farm animal (e.g., goat, sheep, pig, cattle, etc.), or laboratory animal (e.g., mouse, rat, etc.). Preferably, an organism is a human.

### Labels

In some embodiments, the disclosure provides methods and compositions that include labels for the highly sensitive detection and quantitation of molecules, e.g., of markers.

Many strategies can be used for labeling target analytes to enable their detection or discrimination in a mixture of particles. The labels can be attached by any known means, including methods that utilize non-specific or specific interactions of label and target analyte. Labels can provide a detectable signal or affect the mobility of the particle in an electric field. Labeling can be accomplished directly or through binding partners.

Labels can include but are not limited to one or more the following: fluorophores, chromophores, chemiluminescent atoms or compounds, phosphorescent atoms or compounds, electro-chemiluminescent atoms or compounds, micro- or nanoparticles, micro- or nanocrystals, nanodiamonds, up-converting phosphors, micro- or nano-lasers, electron paramagnetic resonance (EPR) labels, nuclear magnetic resonance (NMR)/magnetic resonance imaging (MRI) sensitive labels, plasmon resonance labels, quantum dots, radionuclides, colloidal metals, virus particles, liposomes, micelles, oligonucleotides, peptides, proteins, enzymes, ribozymes, and aptamers.

In some embodiments, the label comprises a binding partner to the molecule of interest, where the binding partner is attached to a fluorescent moiety. The compositions and methods of the disclosure can use highly fluorescent moieties. Moieties suitable for the compositions and methods of the disclosure are described in more detail below. Fluorescent molecules may be attached to binding partners by any known means such as direct conjugation or indirectly (e.g., biotin/streptavidin).

The fluorescent moieties can be fluorescent dye molecules. Examples of fluorescent molecules include but are not limited to ALEXA FLUOR® 488, ALEXA FLUOR® 532, ALEXA FLUOR® 647, ALEXA FLUOR® 680 or ALEXA FLUOR® 700 Brilliant Violet™ molecules (BD Biosciences) such as Brilliant Violet 421™, Brilliant Violet 510™, Brilliant Violet 570™,| Brilliant Violet 605 and ATTO™ dyes (ATTO TECH GmbH) such as ATTO™ 532. In some embodiments, the dye molecules are ALEXA FLUOR® 647 dye molecules.

### Binding Partners

In some embodiments, the binding partner comprises an antibody. In some embodiments, the antibody is a monoclonal antibody. In other embodiments, the antibody is a polyclonal antibody.

The antibody can be specific to any suitable marker. In some embodiments, the antibody is specific to a marker that is selected from the group consisting of cytokines, growth factors, oncology markers, markers of inflammation, endocrine markers, autoimmune markers, thyroid markers, cardiovascular markers, markers of diabetes, markers of infectious disease, neurological markers, respiratory markers, gastrointestinal markers, musculoskeletal markers, dermatological disorders, and metabolic markers.

Any suitable binding partner with the requisite specificity for the form of molecule, e.g., a marker, to be detected can be used. If the molecule, e.g., a marker, has several different forms, various specificities of binding partners are possible. Suitable binding partners are known in the art and include antibodies, aptamers, lectins, and receptors. A useful and versatile type of binding partner is an antibody.

Capture binding partners and detection binding partner pairs, e.g., capture and detection antibody pairs, can be used in embodiments of the disclosure. Thus, in some embodiments, a heterogeneous assay protocol is used in which, typically, two binding partners, e.g., two antibodies, are used. One binding partner is a capture partner, usually immobilized on a solid support, and the other binding partner is a detection binding partner, typically with a detectable label attached. Antibody pairs can be designed and prepared by methods well-known in the art. Compositions of the disclosure include antibody pairs wherein one member of the antibody pair is a label as described herein, and the other member is a capture antibody.

In some embodiments it is useful to use an antibody that cross-reacts with a variety of species, either as a capture antibody, a detection antibody, or both. Such embodiments include the measurement of drug toxicity by determining, e.g., release of cardiac troponin into the blood as a marker of cardiac damage. A cross-reacting antibody allows studies of toxicity to be done in one species, e.g. a non-human species, and direct transfer of the results to studies or clinical observations of another species, e.g., humans, using the same antibody or antibody pair in the reagents of the assays, thus decreasing variability between assays. Thus, in some embodiments, one or more of the antibodies for use as a binding partner to the marker of the molecule of interest, e.g., cardiac troponin, such as cardiac troponin I, can be a cross-reacting antibody. In some embodiments, the antibody cross-reacts with the marker, e.g. cardiac troponin, from at least two species selected from the group consisting of human, monkey, dog, and mouse. In some embodiments, the antibody cross-reacts with the marker, e.g., cardiac troponin, from the entire group consisting of human, monkey, dog, and mouse.

The above detailed description describes various features and functions of the disclosed systems, devices, and methods with reference to the accompanying Figures. In the Figures, similar symbols typically identify similar components, unless context dictates otherwise. The illustrative embodiments described in the detailed description, Figures, and claims are not meant to be limiting. Other embodiments can be utilized, and other changes can be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### EMBODIMENTS

Embodiment 1. An analyzer system for detecting the presence of a target analyte in a sample, the analyzer system comprising:
a motor;
a dock coupled to the motor so as to be rotated by actuation of the motor;
a cartridge held in the dock and including a fluid circuit configured to receive a sample, isolate a target analyte of the sample, and collect a quantity of a first label that is proportional to a quantity of the target analyte in the sample, the fluid circuit including:
   a sample port configured to receive a sample,
   a mixing chamber in fluid communication with the sample port and configured to mix at least a portion of the sample so as to bind the target analyte with the first label, and
   a fluid inlet port in fluid communication with the mixing chamber and configured to receive wash buffer and elution buffer,
   wherein the fluid circuit includes an isolated path extending from the fluid inlet port to the mixing chamber;
a fluid delivery line configured to be coupled to the fluid inlet port so as to deliver fluid to the cartridge through the fluid inlet port and push the fluid along the isolated path toward the mixing chamber;
a first magnet secured on a stage that is movable with respect to the cartridge and configured to move paramagnetic beads within the cartridge;
a first electromagnetic radiation source configured to provide electromagnetic radiation to form an interrogation space within a detection chamber of the cartridge;
a first detector configured to detect electromagnetic radiation emitted in the interrogation space by a label if the label is present in the interrogation space; and
a controller configured to identify the presence of the target analyte in the sample based on the electromagnetic radiation detected by the first detector.

Embodiment 2. The analyzer system of embodiment 1, further comprising a second magnet arranged to be positioned on opposite side of the cartridge as the first magnet.

Embodiment 3. The analyzer system of embodiment 1 or embodiment 2, further comprising a pump configured to push wash buffer and elution buffer through the fluid delivery line and into the cartridge via the inlet port.

Embodiment 4. The analyzer system of any of embodiments 1 to 3, further comprising a distribution valve coupled to the fluid delivery line, a wash buffer port, an elution buffer port, and the pump.

Embodiment 5. The analyzer system of embodiment 4, further comprising a priming line disposed between the distribution valve and the pump, wherein the distribution valve is configured to sequentially connect the elution buffer port and wash buffer port to the priming line to load the priming line, and then connect the priming line to the fluid delivery line.

Embodiment 6. The analyzer system of any of embodiments 1 to 5, wherein the cartridge includes lyophilized reagent in the mixing chamber.

Embodiment 7. The analyzer system of any of embodiments 1 to 5, wherein the cartridge includes a liquid reagent port.

Embodiment 8. The analyzer system of any of embodiments 1 to 7, wherein the fluid circuit is one of a plurality of fluid circuits in the cartridge.

Embodiment 9. The analyzer system of embodiment 8, wherein each of the fluid circuits has the same configuration and includes a working channel along the isolated path between the mixing chamber and the inlet port.

Embodiment 10. The analyzer system of embodiment 9, wherein the working channels extend along a common circular line.

Embodiment 11. The analyzer system of embodiment 10, wherein the motor and dock are arranged to rotate the cartridge about an axis that is perpendicular to a plane of the fluid circuit.

Embodiment 12. The analyzer system of embodiment 9, wherein the working channels extend along a common straight line.

Embodiment 13. The analyzer system of embodiment 12, wherein the motor and dock are arranged to rotate the cartridge about an axis that is parallel to a plane of the fluid circuit.

Embodiment 14. A method comprising:
receiving a cartridge in an analyzer system such that the cartridge is coupled to a motor of the analyzer system;
rotating the cartridge using the motor so as to move a volume of a sample toward a mixing chamber in the cartridge;
mixing the volume of the sample in the mixing chamber by moving the cartridge so as to bind the target analyte, a label, and paramagnetic capture beads;
introducing a series of fluids from a primed fluid delivery line into the cartridge through a fluid inlet port, the series of fluids including wash buffer and elution buffer;
pushing the series of fluids along an isolated path in a first direction from the fluid inlet port to the mixing chamber;
using a magnet, moving the paramagnetic capture beads out of the mixing chamber along the isolated path in a second direction toward the fluid inlet port.

Embodiment 15. The method of embodiment 14, further comprising:
directing electromagnetic radiation from an electromagnetic radiation source to form an interrogation space within the cartridge;
receiving, in a detector, electromagnetic radiation emitted in the interrogation space if the fluorescent is present in the interrogation space; and
identifying, using a controller, the presence of the target analyte in the sample based on electromagnetic radiation detected by the detector.

Embodiment 16. The method of embodiment 15, wherein the label is a fluorescent label.

Embodiment 17. The method of any of embodiments 14 to 16, further comprising loading the primed fluid delivery line with the series of fluids by sequentially coupling the fluid delivery line to an elution buffer port and a wash buffer port using a distribution valve.

Embodiment 18. The method of any of embodiments 14 to 17, wherein the cartridge is rotated about an axis that is perpendicular to a plane of the fluid circuit.

Embodiment 19. The method of embodiment 18, wherein moving the cartridge to mix the quantity of the sample includes further rotating the cartridge.

Embodiment 20. The method of embodiment 18 or 19, wherein the fluid circuit is one of a plurality of fluid circuits disposed around a center of the cartridge.

Embodiment 21. The method of embodiment 20, wherein each of the fluid circuits has the same configuration and includes a working channel along the isolated path between the respective mixing chamber and inlet port.

Embodiment 22. The method of embodiment 21, wherein the working channels extend along a common circular line disposed at a fixed radius from the center of the cartridge.

Embodiment 23. The method of any of embodiments 14 to 17, wherein the cartridge is rotated about an axis that is parallel to a plane of the fluid circuit.

Embodiment 24. The method of embodiment 23, wherein moving the cartridge to mix the quantity of the sample includes moving the cartridge in a direction that is parallel to the plane of the fluid circuit.

Embodiment 25. The method of embodiment 23 or 24, wherein the fluid circuit is one of a plurality of fluid circuits disposed in a row across the cartridge.

Embodiment 26. The method of embodiment 25, wherein each of the fluid circuits has the same configuration and includes a working channel along the isolated path between the respective mixing chamber and inlet port.

Embodiment 27. The method of embodiment 26, wherein the working channels extend along a common straight line.

1. An analyzer system for detecting the presence of a target analyte in a sample, the analyzer system comprising:
a motor;
a dock coupled to the motor so as to be rotated by actuation of the motor;
a cartridge held in the dock and including a fluid circuit configured to receive a sample, isolate a target analyte of the sample, and collect a quantity of a first label that is proportional to a quantity of the target analyte in the sample, the fluid circuit including:
a sample port configured to receive a sample,
a mixing chamber in fluid communication with the sample port and configured to mix at least a portion of the sample so as to bind the target analyte with the first label, and
a fluid inlet port in fluid communication with the mixing chamber and configured to receive wash buffer and elution buffer,
wherein the fluid circuit includes an isolated path extending from the fluid inlet port to the mixing chamber;
a fluid delivery line configured to be coupled to the fluid inlet port so as to deliver fluid to the cartridge through the fluid inlet port and push the fluid along the isolated path toward the mixing chamber;
a first magnet secured on a stage that is movable with respect to the cartridge and configured to move paramagnetic beads within the cartridge;
a first electromagnetic radiation source configured to provide electromagnetic radiation to form an interrogation space within a detection chamber of the cartridge;
a first detector configured to detect electromagnetic radiation emitted in the interrogation space by a label if the label is present in the interrogation space; and
a controller configured to identify the presence of the target analyte in the sample based on the electromagnetic radiation detected by the first detector.

2. The analyzer system of claim 1, further comprising a distribution valve coupled to the fluid delivery line, a wash buffer port, an elution buffer port, and the pump.

3. The analyzer system of claim 2, further comprising a priming line disposed between the distribution valve and the pump, wherein the distribution valve is configured to sequentially connect the elution buffer port and wash buffer port to the priming line to load the priming line, and then connect the priming line to the fluid delivery line.

4. The analyzer system of claim 1, wherein the cartridge includes lyophilized reagent in the mixing chamber.

5. The analyzer system of claim 1, wherein the cartridge includes a liquid reagent port.

6. The analyzer system of claim 1, wherein the fluid circuit is one of a plurality of fluid circuits in the cartridge, and
wherein each of the fluid circuits has the same configuration and includes a working channel along the isolated path between the mixing chamber and the inlet port.

7. The analyzer system of claim 6, wherein the working channels extend along a common circular line, and
wherein the motor and dock are arranged to rotate the cartridge about an axis that is perpendicular to a plane of the fluid circuit.

8. The analyzer system of claim 6, wherein the working channels extend along a common straight line, and
wherein the motor and dock are arranged to rotate the cartridge about an axis that is parallel to a plane of the fluid circuit.

9. A method comprising:
receiving a cartridge in an analyzer system such that the cartridge is coupled to a motor of the analyzer system;
rotating the cartridge using the motor so as to move a volume of a sample toward a mixing chamber in the cartridge;
mixing the volume of the sample in the mixing chamber by moving the cartridge so as to bind the target analyte, a label, and paramagnetic capture beads;
introducing a series of fluids from a primed fluid delivery line into the cartridge through a fluid inlet port, the series of fluids including wash buffer and elution buffer;
pushing the series of fluids along an isolated path in a first direction from the fluid inlet port to the mixing chamber;
using a magnet, moving the paramagnetic capture beads out of the mixing chamber along the isolated path in a second direction toward the fluid inlet port.

10. The method of claim 9, further comprising:
directing electromagnetic radiation from an electromagnetic radiation source to form an interrogation space within the cartridge;
receiving, in a detector, electromagnetic radiation emitted in the interrogation space if the fluorescent is present in the interrogation space; and
identifying, using a controller, the presence of the target analyte in the sample based on electromagnetic radiation detected by the detector.

11. The method of claim 10, wherein the label is a fluorescent label.

12. The method of claim 9, further comprising loading the primed fluid delivery line with the series of fluids by sequentially coupling the fluid delivery line to an elution buffer port and a wash buffer port using a distribution valve.

13. The method of claim 9, wherein the cartridge is rotated about an axis that is perpendicular to a plane of the fluid circuit, and moving the cartridge to mix the quantity of the sample includes further rotating the cartridge.

14. The method of claim 13, wherein the fluid circuit is one of a plurality of fluid circuits disposed around a center of the cartridge, wherein each of the fluid circuits has the same configuration and includes a working channel along the isolated path between the respective mixing chamber and inlet port, and wherein the working channels extend along a common circular line disposed at a fixed radius from the center of the cartridge.

15. The method of claim 9, wherein the cartridge is rotated about an axis that is parallel to a plane of the fluid circuit, and moving the cartridge to mix the quantity of the sample includes moving the cartridge in a direction that is parallel to the plane of the fluid circuit.

16. The method of claim 15, wherein the fluid circuit is one of a plurality of fluid circuits disposed in a row across the cartridge, wherein each of the fluid circuits has the same configuration and includes a working channel along the isolated path between the respective mixing chamber and inlet port, and wherein the working channels extend along a common straight line.
